(19) United States
(12) Patent Application Publication
(10) Pub. No.: US 2024/0274022 A1
(43) Pub. Date: Aug. 15, 2024

(54) SYSTEM AND METHOD FOR AUTOMATED REAL-TIME FEEDBACK OF A MUSICAL PERFORMANCE

(71) Applicant: Magic Sheet Music Incorporated, Akron, OH (US)

(72) Inventors: Konrad Binienda, Cleveland, OH (US); Kenrick Licorish, San Jose, CA (US)

(73) Assignee: Magic Sheet Music Incorporated, Akron, OH (US)

(21) Appl. No.: 18/167,395

(22) Filed: Feb. 10, 2023

(51) Int. Cl. G09B 5/02; G09B 15/00; G10G 3/04; G10H 1/00

(52) U.S. Cl. CPC G09B 5/02; G09B 15/00; G10G 3/04; G10H 1/0008; G10H 2210/076; G10H 2210/086; G10H 2210/091; G10H 2220/121; G10H 2240/285; G10H 2250/311

(57) ABSTRACT

A music performance feedback tool is described herein that enables a musician to play freely and receive feedback in real-time. The tool tracks the musician as they progress through a piece and returns optimal feedback given an input sequence produced by the musician. The tool enables musicians to practice in a fashion that is most natural and pedagogically correct. The tool provides musicians with annotations indicating what notes in the score they failed to play, erroneously added notes, and the like. The tool further provides the musician with tempo and rhythmic feedback.

### BACKGROUND

When a musician practices, they attempt to play a sequence of notes to replicate a sequence provided in a sheet of music. Feedback on a performance enables the musician to improve. Conventional music feedback solutions typically exist in one of the following categories.

In the first category, a system determines feedback based on a chronological order of events. For example, if we have notes A, B, C, D, and E occurring chronologically, the system waits for the musician to play A, then will not accept any input as correct other than B. Input continues to be judged incorrect even if the musician merely skips B and goes on to play C, D, and E correctly.

In a second category, systems employ a scrolling algorithm. A scrolling algorithm may be found in many games. The scrolling algorithm features a vertical line that scrolls across the notes in a metronomic fashion from the beginning of the piece to the end. These systems, however, require a practice tempo to be a performance tempo. It is highly inefficient to practice a piece at a speed that exceeds the ability of the performer—especially when practicing in large slices or from beginning to end. This way of practicing creates bad habits and reinforces them. It is more efficient to practice in slower tempos while solving technical problems and learning notes. Getting closer to a performance tempo involves gradually increasing the tempo or practicing at a fast tempo but in short stints that work on a few beats at a time.

A third category of existing solutions involves combinations of the two solutions described above. These solutions, however, include the drawbacks present in both.

### SUMMARY

A simplified summary is provided herein to help enable a basic or general understanding of various aspects of exemplary, non-limiting embodiments that follow in the more detailed description and the accompanying drawings. This summary is not intended, however, as an extensive or exhaustive overview. Further, this summary is not intended to identify key factors or essential features of the claimed subject matter, nor is it intended to be used to limit the scope of the claimed subject matter.

In one aspect, a system is provided. The system includes a processor coupled to a memory having computer-executable instructions. When the instructions are executed by the processor, the processor is configured to generate an input transcript from input of a musical performance, generate a reference transcript from a musical score associated with the input, determine an alignment between the input transcript and the reference transcript using a directed graph technique, and output feedback on the musical performance based on the alignment determined.

In another aspect, a method for providing real-time feedback on a musical performance is described. The method include acquiring input of the musical performance. The method also includes generating an input transcript of the musical performance based on the input. In addition, the method includes comparing the input transcript to a reference transcript of a musical score associated with the musical performance to determine an alignment. Further, the method includes generating annotations based on the alignment, wherein the annotations include corrective transformations to the musical performance. The method also includes displaying, in real time, the annotations on a rendered representations of the musical score as feedback to a performer.

In yet another aspect, a non-transitory, computer-readable storage medium having stored thereon computer-executable instructions is provided. The instructions, when executed by a processor, configure the processor to: acquire digital input of the musical performance captured by an input device; process a sample of the digital input and provide processed digital input to neural network to generate active note probabilities; apply a threshold to the active note probabilities to determine actual active notes, group active notes occurring within a predetermined amount of time; append grouped active notes associated with the sample to a data structure representing an input transcript of the musical performance; generate a grid graph based on the input transcript and a reference transcript corresponding to a musical score associated with the musical performance; traverse the grid graph to identify one or more paths of alignment; evaluate the one or more paths of alignment based on one or more criteria, select an alignment from the one or more paths of alignment as a solution alignment; identify a series of edits, based on the solution alignment, to transform the input transcript into the reference transcript; generate annotations based on the series of edits; and output display data for displaying the annotations in connection with a visual representation of the musical score in real-time as feedback on the musical performance, wherein the display data is automatically updated to change the visual representation of the musical score during the performance to simulate a page turn event.

To the accomplishment of the foregoing and related ends, the following description and annexed drawings set forth certain illustrative aspects and implementations. These are indicative of but a few of the various ways in which one or more aspects may be employed. Other aspects, advantages and novel features of the disclosure will become apparent from the following detailed description when considered in conjunction with the annexed drawings.

### BRIEF DESCRIPTION OF THE DRAWINGS

Various non-limiting embodiments are further described in the detailed description given below with reference to the accompanying drawings, which are incorporated in and constitute a part of the specification.

FIG. 1 illustrates an exemplary, non-limiting implementation of a performance evaluation engine according to various aspects.

FIG. 2 illustrates an exemplary, non-limiting implementation of the various aspects of the performance evaluation engine of FIG. 1.

FIG. 3 illustrates a flowchart of an exemplary, non-limiting method for providing real-time feedback of a musical performance according to various aspects.

FIG. 4 illustrates an exemplary, non-limiting diagram of a user interface of a real-time musical performance feedback system.

FIG. 5 illustrates an exemplary, non-limiting diagram of a user interface of a real-time musical performance feedback system.

FIG. 6 illustrates an exemplary, non-limiting diagram of a user interface of a real-time musical performance feedback system.

FIG. 7 illustrates an exemplary, non-limiting software class description for an interactive performance scoring system according to various aspects.

FIG. 8 illustrates a flowchart of an exemplary, non-limiting start up routine.

FIG. 9 illustrates a flowchart of an exemplary, non-limiting software loop.

FIG. 10 is a depiction of sampling frequency versus wave frequency being measured.

FIG. 11 depicts wave addition and wave subtraction.

FIG. 12 is a schematic diagram of data transformation from live audio to onset matrix.

FIG. 13 depicts modes of vibration for a string.

FIG. 14 depicts the data transformations from onset matrix to transcript.

FIG. 15 illustrates sequence alignment in an exemplary scenario.

FIG. 16 illustrates a grid graph for a directed graph technique of sequence alignment.

FIG. 17 illustrates an optimal path on the grid graph of FIG. 16.

FIG. 18 illustrates an alternative path on the grid graph of FIG. 16.

FIG. 19 illustrates a complete directed graph depicted all possible alignment paths.

FIG. 20 illustrates one step of a search strategy of the directed graph.

FIG. 21 illustrates one step of a search strategy of the directed graph.

FIG. 22 illustrates one step of a search strategy of the directed graph.

FIG. 23 illustrates one step of a search strategy of the directed graph.

FIG. 24 is a schematic block diagram of an exemplary, non-limiting embodiment for a computing device associated with the systems and techniques of FIGS. 1-23.

### DETAILED DESCRIPTION

As described above, existing music feedback products typically require a musician to play in strict order and/or play with strict timing. These products have drawbacks. For example, a strict order requirement does not account for rhythm accuracy at all. In music, not only is the order of notes relevant, but also the precise ratio of timings between the notes. Further, as mentioned above, a strict order requirement penalizes a musician for missing an entire sequence of notes even if all notes are correct but the first note in the sequence is missing. With strict timing requirements, other drawbacks manifest. First, as noted above, it is inefficient to require performance tempo during practice. Further, another issue of strict timing requirement is that a perfectly metronomic playthrough is not expressive. Playing in a metronomic fashion can be used as a pedagogical tool to clarify the rhythm, but ultimately is not the goal of a musical performance. Thus, a tool which is only capable of metronomic feedback is limited in utility.

A music performance feedback tool is described herein that enables a musician to play freely and receive feedback. The tool tracks the musician as they progress through a piece and returns mathematically globally optimal feedback given an input sequence produced by the musician. The tool enables musicians to practice in a fashion that is most natural and pedagogically correct.

In one aspect, a sequence of notes played by a musician can be an input sequence. Given an input sequence X, a sequence representing the notes in the score Y, and a misalignment cost function S, the tool returns a globally optimal alignment between sequences X and Y that minimizes cost S. Using this alignment, the tool determines a minimal number of edits necessary to turn X into Y. In other words, the tool performs a function analogous to that performed by a musical educator as the tool informs musicians on how they should edit their performance in order to best match the score.

The tool provides musicians with annotations indicating what notes in the score they played correctly and which notes they failed to play. The tool further shows musicians erroneously added notes annotated at the correct position in the score. For example, if the score shows a C followed by a G and the musician plays C F G #G instead, the tool will correctly show the musician that they erroneously played F and G # between C and G.

In another aspect, the tool provides musicians with tempo and rhythmic feedback. The alignment technique enables flexible tracking musicians as they progress through a piece. During tracking, the tool timestamps the arrival of the performance at each point in the score. Using these timestamps, the tool provides musicians with feedback on their interval tempo at all points during their performance.

In another aspect, the tool provides musicians with volume feedback. A volume prediction is made for every note played by the user. Using these predictions, volume of each performed noted can be communicated to the user.

The claimed subject matter is now described with reference to the drawings, wherein like reference numerals are generally used to refer to like elements throughout. In the following description, for purposes of explanation, numerous specific details are set forth in order to provide a thorough understanding of the claimed subject matter. It may be evident, however, that the claimed subject matter may be practiced without these specific details. In other instances, structures and devices are shown in block diagram form in order to facilitate describing the claimed subject matter.

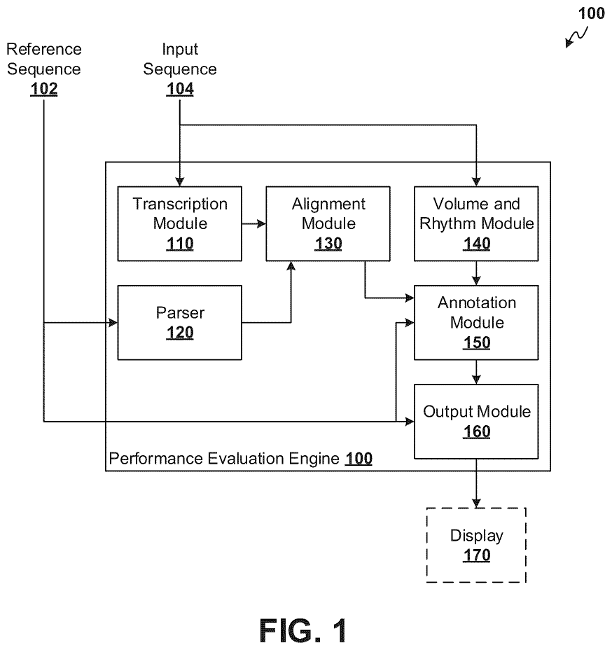

Referring initially to FIG. 1, a performance evaluation engine 100 for providing feedback on a musical performance is illustrated. In an example, the performance evaluation engine 100 receives a reference sequence 102 and an input sequence 104, and outputs feedback that can be shown to a musician on a display 170. The input sequence 102, in an example, can be a sequence of notes performed by the musician. The input sequence 102 can be an audio recording of the performance. Alternatively, the input sequence 102 may be MIDI data. The reference sequence 102 can be a sequence of notes embodied, for example, on sheet music. Accordingly, the reference sequence 102 can be a musical score that is performed by the musician to generate the input sequence 104.

As shown in FIG. 1, the input sequence 104 is provided to a transcription module 110 that generates an input transcript. The input transcript, for example, is a transcript of the musical performance indicated by the input sequence 104. Similarly, a parser 120 can generate a reference transcript from the reference sequence 102. In an example, the transcripts can be arrays of bitarrays. Each bitarray indicates notes that are active at a given time. The sequence of bitarrays provided in the array indicate an order in which each note or group of notes become active. It is to be appreciated that other formats for the transcripts can be employed provided the formats enable comparison. Exemplary transcription and/or parsing techniques are described in greater detail below.

The transcripts respectively indicating the input sequence 104 and reference sequence 102 are input to an alignment module 130. The alignment module 130, in an example, employs a sequence alignment technique to determine a best possible alignment between the input sequence 104 and the reference sequence 102. With this alignment, the alignment module 130 can determine a series of edits to transform the input sequence 104 into the reference sequence 102. For example, the edits may include adding a note, deleting a note, replacing a note, etc.

The series of edits can be provided to an annotation module 150. The annotation module 150 converts the series of edits into annotations that can be displayed to provide feedback to the musician. The annotations, for example, represent note additions, note deletions, note substitutions, etc. The annotations, once generated, can be provided to an output module 160 that generates display data output to display 170. In an example, the display data may include a visual representation of the musical score (i.e. reference sequence) and the annotations indicate ways to change the musical performance to match the music score. That is, the annotations may be displayed on the musical score.

In another aspect, a volume and rhythm module 140 can generate volume and/or rhythm feedback. The volume and rhythm feedback can be provided to the annotation module 150 that further generates annotations related to volume or tempo. These annotations can be incorporated into the display data output to display 170.

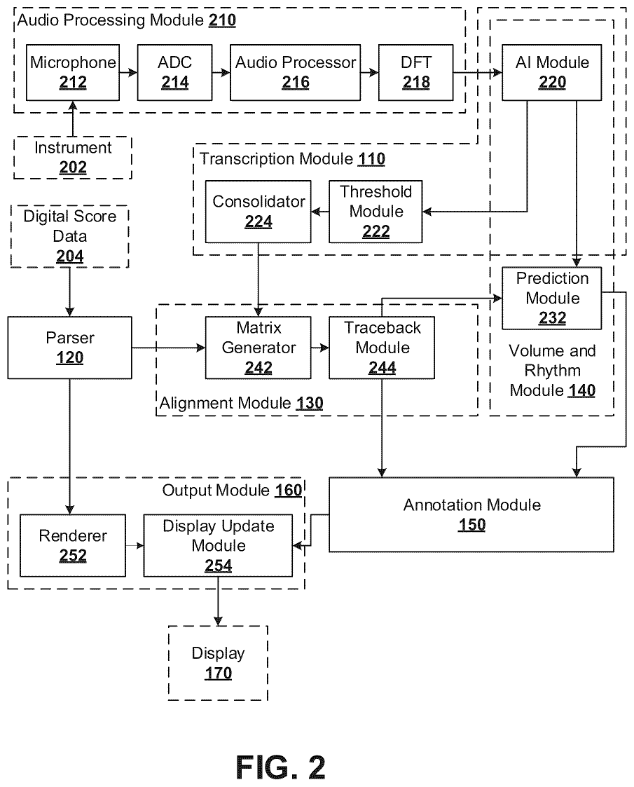

Turning now to FIG. 2, an exemplary implementation of the performance feedback engine 100 and various modules thereof is depicted. In this example, a live audio recording is input and a music score is updated in real-time with feedback based on the audio recording. It is to be appreciated that the implementation shown in FIG. 2 is one way to implement the engine 100 and modules of FIG. 1 and is not intended to limit the claimed subject matter.

According to the example of FIG. 2, a musician, using instrument 202, can create a musical performance. The musical performance is acquired and processed by an audio processing module 210. For example, a live audio recording of the musical performance is captured by a microphone 212. The microphone 212 generates an analog signal that is converted into a digital signal by an analog-to-digital converter (ADC) 214.

Audio processor 216 can perform additional audio processing. For example, audio processor 216 can perform signal amplification, high pass filtering, and sampling. Further, the audio processor 216 can also perform dithering. In one example, the audio is sampled at a rate that is at least twice the highest frequency desired to be detected.

Audio data may be streamed from ADC 214 and stored in a buffer. When the buffer fills to a particular threshold (e.g. 512 datapoints, 1/32 seconds of audio data, etc.), data is pulled from the buffer for further processing. New data pulled from the buffer is processed and appended to data previously processed as described below.

The audio processing module 210 further includes discrete Fourier transform (DFT) 218 that converts a one-dimensional audio signal into a two-dimensional spectrogram of the audio.

The spectrogram is provided to the transcription module 110 to generate a transcript of the musical performance. As shown in FIG. 2, the transcription module 110 can include an artificial intelligence (AI) module 220. In one example, the AI module 220 may be a neural network. The neural network takes as input the spectrogram and outputs a matrix representing onset probabilities. In an example, a first axis (e.g. y axis) of the matrix may have 88 rows representing 88 notes of a piano keyboard, and a second axis (e.g. x axis) of the matrix represents a time domain where each column is 1/32 seconds of time. Each cell of the matrix is a number between 0 and 1, which represents the probability of a given note occurring at a given moment in time.

The transcription module 110 further includes a threshold module 222 that applies a threshold to the matrix output of the AI module 220. In particular, the threshold module 222 applies a threshold to each cell of the matrix. In an example with a threshold of 0.5, if the number in a cell is greater than 0.5, then the threshold module 222 marks that cell as true. If the number in the cell is less than 0.5, then the threshold module 222 marks that cell as false. After thresholding, the matrix represents the notes determined to be actually occurring at a given moment in time.

After the threshold module 222, the transcription module 110 can employ a consolidator 224. The consolidator 224 groups notes together that occur within a predetermined amount of time to each other into chords. In one example, the predetermined amount of time may be 50 milliseconds. In addition, the consolidator 224 can prune columns of the matrix without any active notes.

After consolidation, the transcription module 110 can output the musical performance performed by the musician on the instrument 202 as a transcript. As described above, the transcript may be an array of bitarrays. A parser 120 can generate a similarly structured transcription from digital score data 204. In an example, the digital score data 204 represents a musical score corresponding to the piece of music performed by the musician on the instrument 202. The digital score data 204 may be a digital representation of the musical score in a computer-readable format that is readily parsed by parser 120. In another example, the digital score data 204 may be a scanned version of sheet music and parser 120 employs computer vision techniques. The output of parser 120 is a transcript of the musical score in a similar format as the transcript output by transcription module 110. For example, the output of parser 120 may also be an array of bit arrays representing the musical score.

The transcript provided by the transcription module 110, which may be referred to as an input transcript, and the transcript provided by the parser 120, which may be referred to as a reference transcript, are input to alignment module 130 that generates an alignment between the two.

In one example, alignment module 130 may utilize a sequence alignment or directed graph technique to determine the alignment between the input transcript and the reference transcript. As shown, the alignment module 130 can include a matrix generator 242 that creates a matrix or a grid graph based on the input transcript and the reference transcript. In an example, the matrix or grid graph can include indices of the input transcript along one axis and indices of the reference transcript along another axis. The grid graph is traversed with a traceback module 244 to create an alignment. In an aspect, the traceback module 244 may traverse the graph and identify one or more paths of alignment. Each path of alignment may represent one possible alignment or solution between the input transcript and the reference transcript. Each possible alignment encodes edits to transform the input transcript into the reference transcript. The paths of alignment can be evaluated based on one or more criteria and a particular alignment may be selected based on the criteria. In one example, an optimization function can be utilized to select a particular alignment. An exemplary technique for alignment and solution selection is described later.

As noted, the alignment selected indicates a series of edits. These edits may include the addition of a note, a subtraction of a note, or a substitution of a note. The alignment (and accordingly the series of edits) are provided to the annotation module 150 that determines appropriate annotations to apply to a musical score to indicate corrective actions that may be taken by the musician to improve the performance of the musical score. The annotations may be provided to a display update module 254 of output module 160 to generate corresponding display data that is output to display 170. The output module 160 further includes a renderer 252 that renders a visual representation of the musical score. The visual representation of the musical score is combined with the annotations by the display update module such that the display data includes the annotations in connection with a displayable version of the musical score.

As further shown in FIG. 2, volume and rhythm module 140 includes a prediction module 232 that creates a prediction of a volume of the musical performance (e.g. volume or loudness of particular note(s)) and a determination of a rhythm or tempo of the musical performance. The AI module 220, in an example, may generate the volume prediction. For rhythm determination, a timestamp may be acquired for each index of the input transcript. After alignment, the time difference between input bitarrays aligned to adjacent score positions is determined. The interval tempo can then be derived given the time difference and the number of musical beats between the score positions. This tempo may be compared with an expected tempo based on the reference transcript. The volume prediction and tempo comparison may be provided to the annotation module 150 to further create suitable annotations indicating loudness and tempo. These annotations can be provided to the display update module 254 to generate visual feedback on volume and rhythm.

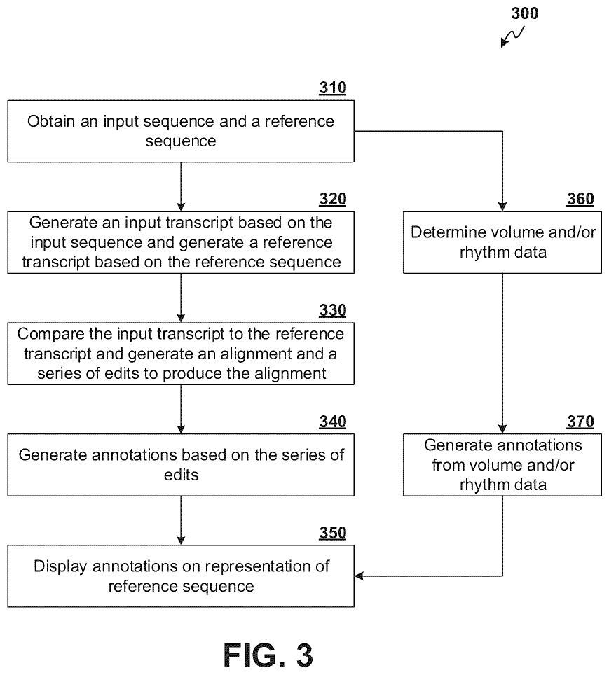

Referring now to FIG. 3, a method 300 for providing real-time feedback of a musical performance by a musician of a musical score is illustrated. The method 300 may be performed by the performance feedback engine 100 described above, for example. The method 300 may commence at 310 where an input sequence and a reference sequence is obtained. The reference sequence may be sourced from a musical score and the input sequence may be an live audio recording of a musical performance of the musical score by a musician.

At 320, an input transcript is generated based on the input sequence and a reference transcript is generated based on the reference sequence. In an example, the transcripts may be arrays of bitarrays. Each index of the array includes a bitarray representing a collection of musical notes active at a particular point in time.

At 330, the input transcript and reference transcript are compared and an alignment between the two transcripts is generated. From the alignment, a series of edits can be determined that produce the alignment. The series of edits transform the input transcript into the reference transcript, for example.

At 340, annotations are generated based on the series of edits. The annotations, in an example, are visual feedback of changes the musician may make to improve the musical performance. For example, the annotations may indicate notes that should be removed or notes that should be added. At 350, the annotations are displays on a representation of the musical score (e.g. the reference sequence).

In another aspect of method 300, volume and/or rhythm data is determined at 360. At 370, annotations are generated from the volume and/or rhythm data to provide visual feedback regarding volume of notes played and a tempo of the performance. This visual feedback may also be displayed in connection with the representation of the musical score at 350.

### Exemplary Implementation of a Live Audio Feedback System

A possible implementation of the performance feedback system and method described above is now described. This implementation merely exemplifies one possible manner in which to carry off the aspects and functionality described above. One of ordinary skill in the art would appreciate alternative implementations based on the description herein. This implementation is not intended to limit the claimed subject matter, but simply provides a detailed example of the general system and method above.

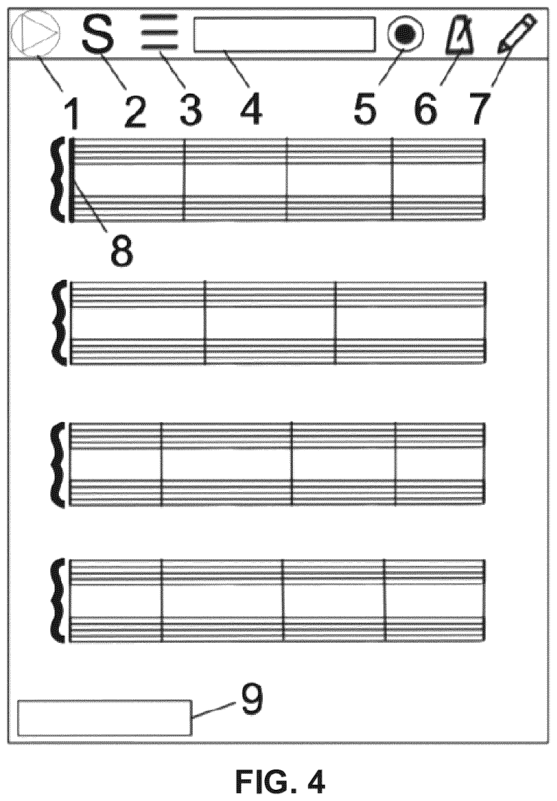

Turning now to FIG. 4, a schematic illustration of an exemplary user interface for a system providing real time annotated feedback on sheet music given a musical performance by a musician on an instrument is depicted. In the exemplary user interface of FIG. 4, a “feedback” button 1 initiates feedback on a real-time performance (acoustic or midi) or feedback on a pre-recorded performance (acoustic or midi). A “select input source” button 2 enables selection of input will be processed from a real-time input source (e.g., a microphone or midi instrument), or whether input will be processed from a prerecorded audio or midi file. A hamburger menu button 3 may be utilized to modify the functionality of the provided feedback. A metadata display 4 communicates information regarding the sheet music such as, for example, a name of the piece and/or a name of the composer. A record button 5 initiates a recording of a musician's performance, which may be an audio or a midi recording. A music tools button 6 accesses additional features such as a metronome feature. A pencil icon button 7 enables a user to add or remove annotations from the sheet music. A start position line 8 may be a thick colored line annotated on top of a measure line selected by the user as the start position of the performance.

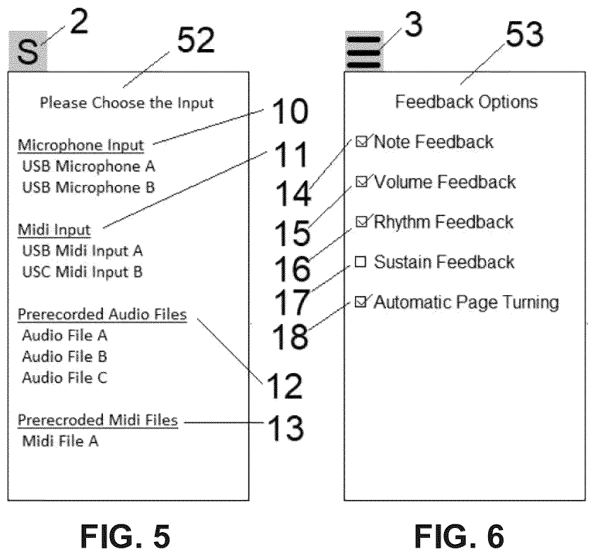

FIG. 5 is a schematic illustration of an exemplary user interface for a drop down menu for selecting the input source for feedback. After pressing or clicking the “select input source” button 2 as shown in FIG. 4, an input source drop down menu 52 appears. A user can select one of the options that appear. Example input sources include, but are not limited to, microphone input 10, midi input 11, pre-recorded audio files 12, and pre-recorded midi files 13.

FIG. 6 is a schematic illustration of an exemplary user interface for a drop down menu for selecting options relevant to the feedback provided to the user. After pressing the “hamburger menu” button 3, the hamburger menu drop down menu 53 appears. A user can select checkboxes to turn on and off feedback features. Example features include, but are not limited to, note feedback 14, volume feedback 15, rhythm feedback 16, sustain feedback 17, and automatic page turning feature 18.

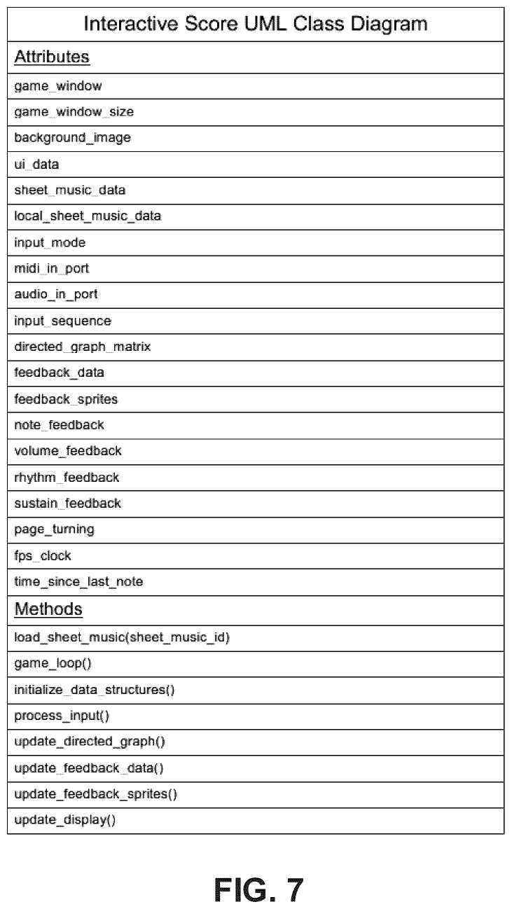

FIG. 7 depicts a UMIL class diagram describing an InteractiveSheetMusic class, which is a software element of a software program implementing the live audio feedback system. The InteractiveSheetMusic class processes user input and renders annotated sheet music based upon that input. The class organizes data and methods to carry out this task. The game_window attribute creates a game window which is drawn to the screen of a computing device to provide a visualization of the user interface. The game_window_size attribute is set equal to a desired size of the game screen and may be expressed as x and y dimensions. A background_image attribute is an image of the sheet music being performed. A ui_data attribute is a python dictionary structure containing data for rendering graphics and interactable elements (e.g., buttons, etc.) to the game_window. A sheet_music_data attribute is a python dictionary structure containing data relevant to the sheet music. A local_score_data attribute is a python dictionary structure containing a subset of the data in sheet_music_data. The subset corresponds to a region of the sheet music the user is currently performing. In an example, the region is portion of the piece the start position line 8 (see FIG. 4) and the end of the piece. An input_mode attribute is a string describing the input mode the user has selected for the performance feedback program to use. Input options include, but are not limited to, live audio, live midi, pre-recorded audio, and pre-recorded midi. A midi_in_port attribute is used to receive streaming data from a user's midi instrument and to store that data in a buffer so that it is ready to be sampled by the program. An audio_in_port attribute is used to receive streaming digital audio data from the analog to digital converter attached to the user's microphone. It stores this data in a buffer so that it can be sampled by the program. An input sequence attribute is used to store a transcript of the user's performance. A directed_graph_matrix attribute is used to store calculations relevant to the directed graph technique of sequence alignment described later. A feedback_data attribute contains feedback data to be annotated to the score. A feedback sprites attribute contains images, which can be rendered to the game_window in order to visually convey feedback to the user. A note_feedback attribute, volume_feedback attribute, rhythm_feedback attribute, and a sustain_feedback attribute are Boolean values that can be set to true or false. These attributes describe whether the user wishes to receive feedback on notes, the volume of each note, rhythm/tempo, and the sustain of each note, respectfully. A page turning attribute is a Boolean value that indicates whether the program will automatically turn the page once an alignment has reached the end of a current page. A fps_clock attribute is used to set a frame rate of the program described in this exemplary implementation. A time_since_last_note attribute stores a time difference between two consecutive notes in the user's performance. This attribute is used to group notes together into chords as well as storing information relevant for rhythm and tempo feedback.

In addition to the attributes described above, the InteractiveSheetMusic class also includes methods to implement the functionality of this example. A load_sheet_musico method receives as input a score id number and returns data necessary to render sheet music to the game_window and to properly position feedback annotations. A game_loop( ) method runs recursively while the program is operating. The method recursively calls a process_input( ) method and an update_display( ) method. The process_input( ) method processes user input so that the user interface can be interacted with and annotated feedback can be provided on a performance. An update_display method updates the game window so that it reflects the program's current internal state. For example, if new feedback annotations have been created since the last call of update_display( ), calling update_display( ) will ensure that those new annotations are displayed to the game_window. The process_input( ) method contains a function called “run_feedback_algorithms”, which is used to update feedback every time the input sequence is modified. The run_feedback_algorithms calls three functions in sequential order. First, a update_direted_graph( ) method is called, which updates directed_graph_matrix to reflect the edited input sequence. Second, an update_feedback_data( ) method is called, which takes the directed_graph_matrix as input and saves the optimal edit sequence to feedback_data. Last, an update_feedback_sprites( ) method is called, which takes feedback_data as input and returns annotation sprites (e.g. sprite objects) that are stored in feedback sprites (e.g. a sprite group).

When the exemplary software program implementing the live audio feedback system is executed, the following operations are carried out by a computing device. FIGS. 4-6 depict the user interface encountered by the user on startup. Startup routines are executed that result in an instance of the interactive_score_class shown in FIG. 7 being initialized (e.g. with my_interactive_score=Interactive_Score( )) and loads sheet music (e.g with my_interactive_score.load_score(score_id_number)). When my_interactive_score is initialized, it opens a game window with the following:
my_interactive_score.game_window(my_interactive_score.game_window_size)

The software sets the default color of the game window to white (my_interactive_score.game_window.fill(255, 255, 255)).

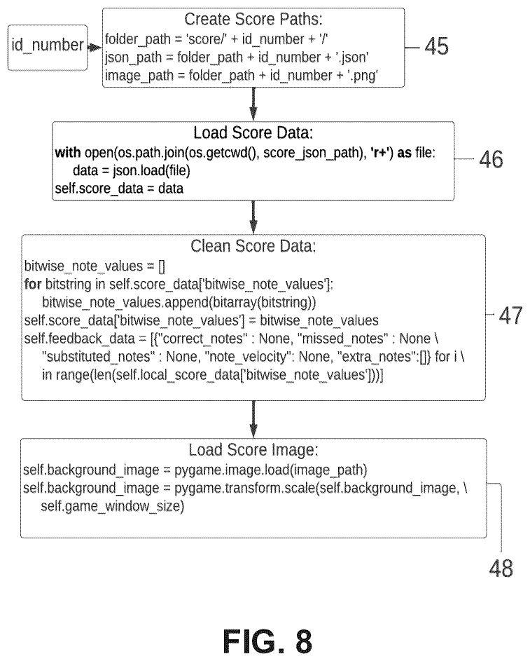

FIG. 8 shows a logical sequence of events which are carried out to load sheet music from storage. The load_score( ) function accepts as input an id_number associated with the piece of music. It uses this ID number to determine the folder path where data relevant to the sheet music can be found (see step 45). Subsequently, the program determines the correct path to a json file containing sheet music data. It also finds the correct path to an image of the sheet music. Next, the program uses the json path to load data from the json (see step 46). At step 47, the program accomplishes two functions. First, it converts a value my_interacive_score.sheet_music_data[‘bitwise_note_values’] from a list of strings to a list of bitarrays. It also sets up a data structure for my_interactive_score.feedback_data (a list of dictionaries). At step 48, the program sets self.background_image to the file indicated by our sheet music image path. The program also stretches this image so that it matches the dimensions of my_interactive_score.game_window_size. The sheet music image can now be displayed by the game_window by calling:
my_interactive_score.game_window.blit(my_interactive_score.background_image, (0,0)) This method call is made whenever my_interactive_score.update_display( ) executes.

Additional UI elements can be added to the game window by using JSON to load data regarding these elements from local storage. A json request is made in a similar fashion as step 46 of FIG. 8. This data loaded from JSON is then saved to my_interactive_score.ui_data. In order to create graphical elements using this data, additional information is acquired. This information includes: the image related to each element, the dimensions of each element, and the x,y coordinate of each element in the game_window. Additionally, if the element is a button, the name of the function to be evaluated if the button is clicked is acquired.

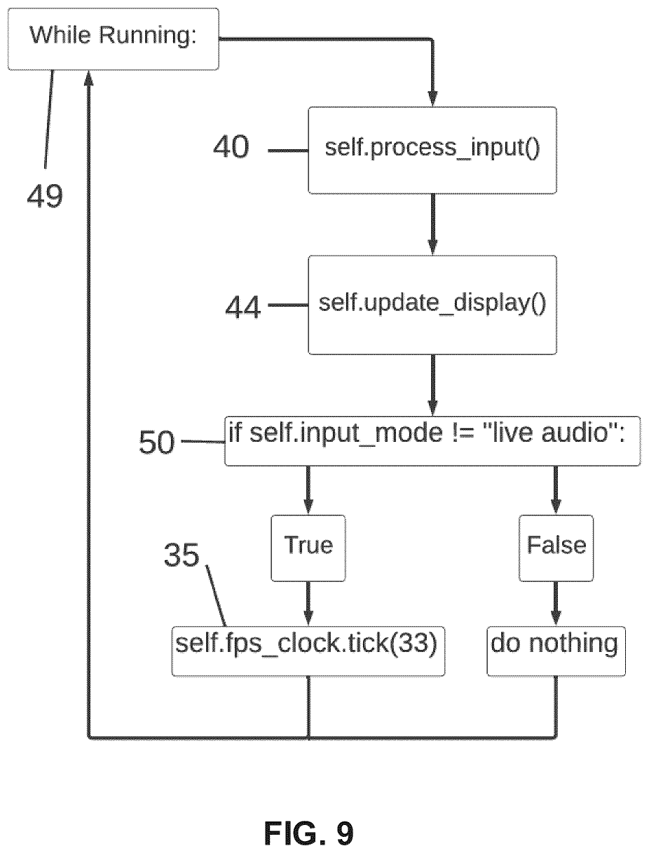

Once the sheet music has been loaded, a game loop is started by calling my_interactive_score.game_loop( ). The functioning of game_loop( ) is shown in FIG. 9. As described above, game_loop( ) recursively calls my_interactive_score.process_input( ) and my_interactive_score.update_display( ). Process input is responsible for processing button clicks and/or touchpad presses as well as handling streaming or prerecorded performance data.

Update_display( ) renders the game window during each loop of game loop( ). Update_display( ) first renders the background image of the sheet music by calling my_interactive_score.game_window.blit(my_interactive_score.background_image, (0,0)). The method then renders additional graphic elements by iterating through the my_interactive_score.graphical_elements and using the blit function to draw these elements to the game window. Last, the method renders any annotations by using a draw( ) function of the sprite group feedback_sprites.

Each time game_loop( ) calls process_input( ), process_input( ) checks to see if any user input has been detected. For example, a loop may be used to iterate through all the interaction events detected since the program has started. The events are checked for mouse clicks (if event.type==pygame.MOUSEBUTTONDOWN). If the mouse has been clicked, the position of the mouse is acquired and the position is checked to determine if it is within the boundaries of any of the graphical elements on the game window. If so, it is checked if there is a function associated with this graphical element. If so, the function associated with this graphical element is evaluated.

In this example, all the buttons of the UI occur in a bar occupying the top of the sheet music interface. The above processing occurs if the mouse click occurs in this top bar region. Alternatively, if the mouse click occurs over the lower region of the UI, then it is determined that the button click is an attempt by the user to change the start position line.

The start position line tells the program the part of the piece the user wants to practice. This way, if the user begins practicing in the middle of the piece, the program will not try to match their performance to the beginning of the score but rather with the section the user intends to play. To position the start position line, the system compares the position of the mouse click to the midpoint of each measure line. The system then moves the start position line to the measure closest to the click. It then finds the subsection of my_interactive_score.sheet_music_data that contains information pertinent to the section of the sheet music between the start position line and the end of the piece. It saves that information to my_inteactive_score.local_sheet_music_data so that pertinent score sequence data can be referenced by the alignment algorithm. When we are ready to begin feedback we can click on the feedback button.

### Live Audio Feedback

The audio processor receives live streaming audio input and creates annotations that can be posted to the sheet music. This process may proceed in four steps. The first step is to receive streaming audio data from a microphone and store the data in a buffer. The second step is to pull data from the buffer in batches and form it into a spectrogram (e.g. an image of the audio). The third step is to transform this spectrogram into a transcription of the performance. The last step is to run this transcription through a series of feedback algorithms to determine annotations to post to the sheet music.

### Receiving Streaming Audio and Storing in a Buffer

An audio library (such as pyaudio) is used to establish a connection to the audio source previously selected from the input source selection drop down menu. Once the audio library is initialized, it will record audio from the microphone and store it in a buffer until batches are pulled from this buffer and run through the rest of the program.

Before audio information is received by the buffer, the audio undergoes a few transformations. The first transformation is the conversion of the audio data from an acoustic sound wave emanating from an instrument to an analog signal representing that sound wave. This transformation is carried out by a microphone. Factors that affect the quality of the recording made by the microphone include the signal-to-noise ratio of the microphone and a maximum sound pressure rating of the microphone. If the maximum sound pressure is exceeded, the audio will experience a form of artifact called clipping.

Once the audio information is transformed into an analog signal, the information in the signal is communicated down a cable until it reaches the analog-to-digital converter (ADC). As the name suggests, the analog to digital converter samples the analog signal to produce a digital signal. While the analog signal is defined as the continuous fluctuation of voltage on the wire connecting the microphone and the ADC, the digital signal is rather composed of discontinuous measurements of the audio signal, which are stored in some data structure such as an array. The sampler of the analog-to-digital converter measures the analog sequence at some specified frequency and stores these measurements in some appropriate data structure. For example, if the ADC samples the analog signal at a frequency of 16384 Hz over a period of one second, the output of the ADC could be represented as an array 16384 indices long with one index corresponding to each of the measurements made.

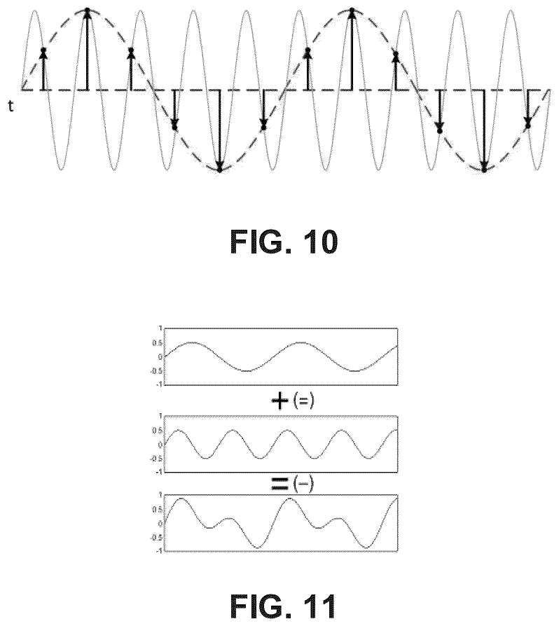

A few factors affect the accuracy of the ADC when converting an analog signal into a digital signal. The first factor involves Fourier theory and Nyquist sampling theory. Fourier theory states any signal can be decomposed into a series of sine waves. Put another way, if enough sine waves are added together in the right proportions, any signal can be reproduced. The Nyquist sampling theorem states that in order for a digital signal to accurately reproduce a sine wave, the sampling frequency of the digital signal must be at least twice that sine wave being measured. When the sampling ratio drops below two, it may be difficult to tell from the digital sample whether a signal of frequency f is being measured or if a lower frequency, called an alias, is instead being measured as both sin waves can perfectly fit the data points provided as shown in FIG. 10.

In order to accurately measure from the target instrument, the analog signal is sampled at a frequency at least twice as high as the fundamental frequency of the highest note that can be produced by the instrument. It is appreciated, however, that the system may sample at a significantly higher frequency rate in order to account for the high frequency overtones that are produced by each note played by an instrument. These overtones may contain useful information.

The analog signal may be passed through a high pass filter to remove frequency information in the analog signal above the Nyquist limit of the digital sampling rate. The high pass filter attempts to remove frequency data above a certain predetermined threshold. Removing this high frequency information improves the overall quality of the audio recording since frequencies of audio likely to contribute to artifact noise are removed.

An additional factor affecting the quality of analog to digital conversion includes the bit depth of each of the samples. The more bits used to record each measurement, the higher the resolution of each measurement. For example, if two bits are used in each measurement, it may only be possible to measure four (2\hat{ }2) levels of audio signal intensity. If eight bits are used, it may be possible to measure 256 (2\hat{ }8) levels of audio signal intensity.

A third factor includes the degree of amplification (gain) of the audio signal before sampling. If there is too much gain, the signal may exceed the range of signal intensity that can be measured. This may cause clipping. If the gain is too small, then the audio is effectively sampled at lower resolution and it is difficult to utilize the full range of signal intensities provided by a selected bit depth.

A fourth factor is measurement noise not due to bit depth but rather due to the inaccuracy of the measurement sampler. Measurement sampler accuracy can degrade at higher recording frequency. A fifth factor includes additional processing steps that may be performed to improve audio quality or perceived audio quality. For example, dithering is a technique in which noise is added to a signal to improve its perceived accuracy.

After the analog signal is converted to a digital signal, the digital signal is then communicated using USB or some other protocol. The software program accesses the USB port to read the digital data. As described above, an audio library (such as pyaudio) is used to read the digital data into a buffer. In an aspect, data may be transported to the buffer so that it has priority on the processor to avoid lost packets of data. Lost packets could lead to artifacts in the recording.

Pulling Data from the Buffer and Creating a Spectrogram

The program will pull data from the buffer in batches of 512 data points. Other batch sizes can alternatively be used. If the audio sampling rate is 16384 data points per second, then 512 data points is equivalent to 1/32 seconds of audio data.

Each time audio is pulled from the buffer, the batch of audio is normalized and appended to a growing list (array) that represents the overall audio recording up to this point in time. Normalization processes the audio so that it most closely resembles the data the transcriber is expecting. Once the audio has been normalized and appended to the audio recording, the recording is converted to a spectrogram using a Fourier transformation.

### Fourier Transformation

As noted above, Fourier theory indicates that any signal can be constructed from a combination of sine waves. This is visualized in FIG. 11.

The inverse is also possible. Given a signal, it can be decomposed into individual frequencies using a Fourier transformation.

An intuitive explanation of the Fourier transformation is that it checks the degree of synchronization between a given sine wave and a target signal. If the signal contains the sine wave, then it is expected that the signal will tend to be positive at the same time the sine wave is positive and negative at the same time the sine wave is negative. This should occur more often than expected by chance.

For example, looking at the addition of sine waves example above, it can be observed that the compound sine wave is somewhat in sync with both the contributing sine waves. While the signal may not always be positive when the corresponding sine wave is positive, the longer duration over which the sine wave is compared to the signal, then the greater the statistical confidence that a true relationship exists.

In practice, the Fourier transformation is carried out by taking the dot product between an array representing a target signal and an array representing a target sine wave. If there is synchronization, the dot product will result in a large positive number. If not, the dot product will produce a result close to zero.

Imagine if the audio signal is broken into small segments. For each segment, the Fourier transformation is performed for every frequency within a defined range and every phase offset of those frequencies. In some situations, phase offset data may be discarded by summing together the phase data for a given frequency. For each small segment of audio, a column of data is created that shows the strength of the frequencies (from lowest to highest) present in that segment of audio. If these columns of data are appended together, a two dimensional plot results where the x axis represents the time dimension and the y dimension represents frequency. This is referred to as a spectrogram.

The particular Fourier transformation, where the signal is cut up into segments and running the transformation over each segment, is called a Discrete Fourier Transformation. A standard Fourier transformation analyzes the whole signal as one segment. A discrete Fourier is appropriate when analyzing signals that are expected to fluctuate over time.

In another aspect, a hanning window function may be utilized to smooth the output of the Fourier transformation. If each bin of audio data is transcribed without any overlap between the bins, the output of the Fourier transformation may have many jagged peaks visible. This results because the signal can fluctuate significantly between time slices. This effect creates strongly discontinuous output. To make the output smoother, each prediction can draw contextual information from neighboring bins. The hanning window function accomplishes this by using a bell curve-like structure where the center of the bell curve lies over the bin of interest and the tails spread out over neighboring bins. In some examples, a hanning window spanning 2048 data points to make predictions for each 512 data point bin may be utilized.

In some aspects, the hanning window should not extend beyond the bounds of the audio sample. If a prediction is made on data close to the last data points of our audio sample, the hanning window might reach beyond the end of the audio sample. When this occurs, the prediction becomes unreliable as the prediction will have to change once new data is sampled and appended to the audio sample to fill a void at the edge of the audio sample. As the hanning window should not a hang over the edge of the data, the hanning window should not be utilized too close to the edge. There may be some latency between when the audio is sampled and when the Fourier transformation on that data is performed. For a hanning window 2048 points wide, according to an example, the latency can be about 1024 data points or 1/16 of a second.

As noted above, the longer a sine wave is compared to a signal the more statistically confident one can be that the signal contains the sine wave. In other words, the longer the signal is listened to, the greater the resolution is achieved with regards to the specific frequencies present in the signal. To illustrate this, imagine a complex signal containing the sine wave 512 is tested using the Fourier transformation against two simple sine waves: 512 and 513. Over short periods of time, both 512 and 513 will appear to be in sync with the signal. However, over long periods of time, 513 will eventually fall farther and farther out of sync with the complex signal. Eventually, the regions where 513 is out of sync with the signal will roughly cancel out the regions where this signal is in sync. Therefore, over these large periods of time, 512 will show a strong positive correlation with the signal while 513 will have a correlation near zero.

Regarding the hanning window, the above logic means that the wider the window, the more data is available for the Fourier transformation and the higher the resolution in the frequency dimension of the spectrogram plot. However, as the window function becomes larger, each prediction is made from larger and larger time frames of data. This results in a loss of resolution in the time dimension. This tradeoff between frequency and time resolution in the spectrogram is a result of Heisenberg's Uncertainty Principle.

The scale of the frequency axis may be important for the spectrogram produced by the Fourier transformation. In one example, a linear scale might be utilized. For instance, consider a scale from 0 to 5000 Hz with equal size hatch marks every 1000 Hz. However, a linear frequency is suboptimal as the frequency of subsequent notes in the musical scale do not increase in a linear fashion. Rather, the frequencies increase in an exponential fashion with each new octave twice the frequency of the last. While the note C4 has a frequency of 261.6 Hz, C5 has a frequency of 523.2 Hz, and C6 has a frequency of 1046.5 Hz. For this reason, with a linear scale for frequency, the frequencies of the highest octave will occupy much more vertical space than the lowest octave. In fact, the highest octave will occupy half of the vertical space with each lower octave occupying exponentially less space.

To address this, a log mel filter may be applied to the spectrogram. The log mel filter will result in each octave being allowed equal territory when plotted on the spectrogram. One parameter of the log mel spectrogram is the number of “bins” used when filtering the output of the Fourier transform. The number of bins can be thought of as the number of vertical pixels in the musical photograph. In conventional music transcription, 229 frequency bins have been described as an acceptable level of resolution for piano transcription. However, a wide range of frequency bins provides satisfactory results. Thus, the number of bins should be sufficiently high so that each note on the instrument has at least one frequency bin dedicated to covering each note.

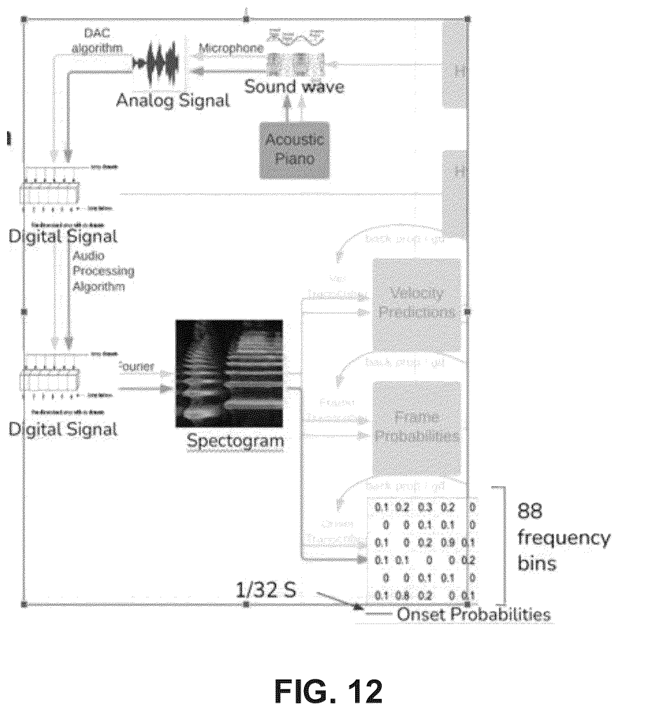

To recap briefly, FIG. 12 illustrates data transformations that have occurred in the live audio feedback system to this point. To summarize, a sound wave from an acoustic instrument is converted by a microphone into an analog signal. Then, the ADC converts the analog signal into a digital signal. Next, audio processing and normalization algorithms modify the digital signal output to prepare the signal for the Fourier transformation. Then, a DFT produces the spectrogram. Subsequently, a Log Mel filter is applied to the spectrogram (not shown), and the spectrogram is input to a music transcription neural network (described below).

Transform Spectrogram into Transcript

Before describing this transformation in detail, it would be helpful to first provide background information on the challenge of automatic music transcription. Traditional musical education describes musical notes as discrete entities that can be defined precisely based on their frequency or pitch. One might imagine that these notes can be seen as peaks in a computerized rendition of the frequencies being played at a moment in time. However, the notion of notes as single frequencies is a human construct, which does not express the physical reality of the harmonic pattern produced when a note is played on an instrument. Music is typically notated based on the way humans perceive it and not based on the physical reality.

In reality, anything that vibrates can vibrate in many ways. The fundamental frequency of a vibrating string is inversely proportional to the length of the string. Fundamental frequency is also dependent on the velocity of the vibratory wave on the string, which can be inferred from the tension of the string, string mass, and string length. Putting it all together, the full equation for the fundamental frequency is f=sqrt(T/(m/L))/2L, where T is the string tension, m is string mass, L is string length.

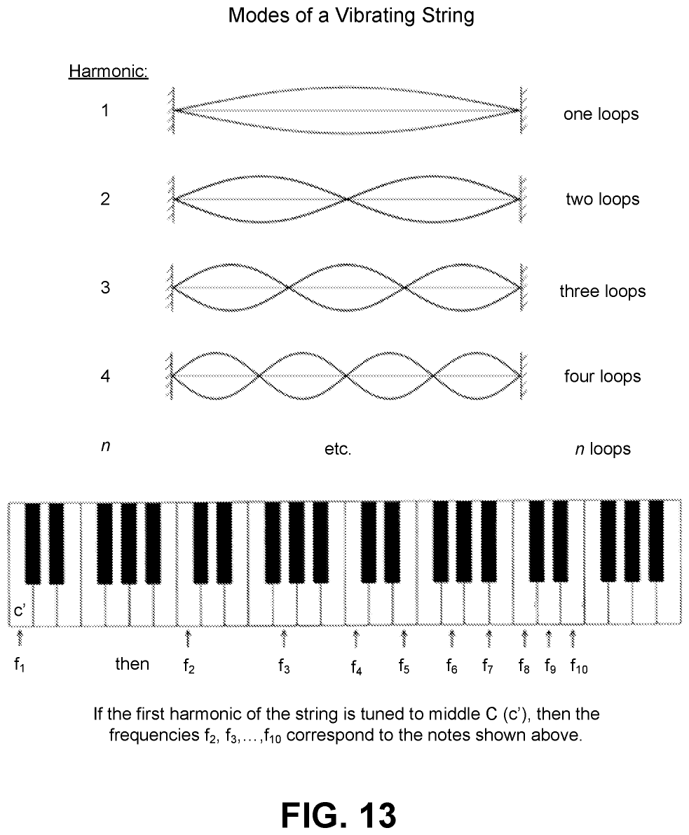

Vibrating objects can be nudged into vibratory patterns in which nodes (points of non-vibration) occur on the string, effectively dividing the string into segments. FIG. 13 illustrates. Since the string is subdivided, the length of the vibrating portions are effectively shorter than the actual length. With one node in the string, the effective length is half the real length and, therefore, the frequency produced is twice the normal frequency. This represents the first harmonic one octave above the fundamental. The rest of the harmonics in the overtone series are produced when additional nodes are added to the string.

Given the above, it has been shown that all of the nodal patterns are produced simultaneously when a real string vibrates. The string will begin to vibrate in a complex pattern that represents a composite of all of the nodal patterns possible. Therefore, the string will produce multiple sounds that together form a harmony of notes composed of the fundamental and its overtones.

With polyharmonic music transcription, for any given pattern of harmonics (as visualized on a spectrogram), there are multiple combinations of notes which can realize that pattern. For example, when one plays C4 (middle C on a piano), the following harmonics are produced: 261 Hz, 523 Hz, 784 Hz, 1046 Hz, 1308 Hz, 1569 Hz, etc. However, if an octave (C4+C5) is played, the same harmonic pattern is produced. The reason is that harmonics of C5 (523 Hz, 1046 Hz, 1569 Hz, etc.) are a subset of the harmonics of C4. C5, therefore, can be described as harmonically redundant with C4.

Polyharmonic music recognition involves recognizing the energy of harmonically redundant notes superimposed upon the harmony of lower notes. For instance, it may be imagined that C4+C5 will have a fluctuant harmonic decay pattern as compared to C4 (as C5 would add strength to only the odd numbered harmonics of C4 (f1, f3, f5, etc.; note that the fundamental frequency is f0). In practice, conventional music transcription programs find this difficult to do as there are many variables, which may affect the robustness and generalizability of this signal (relative loudness of the two notes, baseline harmonic decay fluctuation, etc.). As a result, existing continue to frequently omit these harmonically redundant notes.

### AI Music Transcription System

One model for music transcription is described in “Onsets and Frames: Dual-Objective Piano Transcription” (Hawthorne et al., Jun. 5, 2018, accessible at: https://arxiv.org/pdf/1710.11153.pdf), which is incorporated herein by reference. Existing models, for example, include convolutional neural networks (cnn), recurrent neural networks (rnn), hybrid neural networks (cnn+rnn), transformer models, and harmonic convolution. These models may accept a spectrogram or a digital audio signal as input.

The goal of music transcription is to take, as input, a slice of audio data (in the form of a digital signal or spectrogram) and produce a matrix that shows the probability of note onsets occurring. In order to determine how long each note is being held down and the volume of each note, another matrix may be created that shows note frame or “on status” (as opposed to onset or “turn on status”) as well as a matrix which shows volume predictions for each note at each time period.

To understand the transcription technique, the definition of score alignment accuracy is important. Score alignment accuracy is the accuracy in which “positions” in the score are accurately aligned with “positions” in the input sequence. To define the score “positions”, a one dimensional array in which notes co-occurring in the score are assigned to the same score position. However, if notes are slightly offset by any amount of time (as indicated by the score markings), the notes occupy separate score positions. Input positions are defined in an analogous manner with 50 ms being the threshold for notes being part of the same group or occupying separate input positions.

Accurate alignment is achieved when the input transcription is accurate. The alignment may be globally optimal. Further, with an optimal alignment, the correct annotations to post to the score can be derived from that alignment. In addition, a correct alignment can also help significantly improve the accuracy of the prediction of individual notes. This is due to the use of contextual information in the score, data regarding the frequency of various errors, and Bayesian statistics to improve these predictions.

For the reasons detailed above, achieving correct alignment is an important goal. Accordingly, the AI music transcription system is not tasked with producing the highest score with regards to note accuracy. Rather, due to the way in which the directed graph alignment method described herein operates, certain note mistakes can contribute to misalignment while other note mistakes may not cause misalignment at all. Therefore, consideration about the specific errors that are most impactful to alignment is important.

In general, transcription errors can be grouped into three broad categories: errors of note event detection errors, errors of harmonic identification, and errors or reducing harmonies to individual notes. For each of these error types, another dimension to consider is whether the error is due to something being incorrectly added (precision error) or something being taken away (recall error).

Errors due to note event detection errors occur when an entire input position is missing from the transcript (user played a note or group of notes but AI missed all the notes) or an erroneous input position is added. These errors directly affect sequence alignment accuracy. Less impactful errors include when the harmony at an input position is slightly misidentified or when individual notes at an input position are slightly misidentified. If at least one note in the transcript accurately reflects what was played at the input position, then the score alignment will not be affected (in a polyharmonic situation).

To improve note detection, the AI model may be trained to detect the “onset” of notes rather than the “frames” of notes, which leads to significantly improved alignment accuracy. Onset detection attempts to detect the moment a note first starts while frame detection tries to determine every frame of audio in which a note is active. While onset predictions can be derived from frame predictions by looking for the start point of each of the frames, this may result in very unreliable predictions, in practice.

Consider the following example to illustrated. A user records themselves and plays the note C4 between seconds 2 and 3 in the recording. The frame prediction will attempt to turn all 32 time slices between seconds 2 and 3 to positive. However, what often happens is that the frame prediction will intermittently get confused and drop frames. It may, for example, flicker off twice between seconds 2 and 3. This will result in C4 being detected as having 3 onsets instead of one. In addition, the frame prediction may also get confused and think that an upper harmonic of C4 is an active note and accidentally transcribe this note. Due to these issues, these frame predictions have very low precision and subsequently poor note event detection.

In addition to using note onsets instead of frames, additional important design features include using a high resolution spectrogram. When note onsets occur, there is a very rapid increase in sound energy registered by the spectrogram. This sudden increase in energy provides the AI with an important clue that a note is occurring and helps it avoid note event detection errors. However, this increase in energy occurs much faster than the resolution of many spectrograms, including that used for the onset and frames model. While time slices in onset and frames have −33 ms of resolution, the energy change related to a note onset can be detected within 5 ms of occurrence. Having a high resolution spectrogram helps the AI more accurately characterize these onsets and, therefore, have more confidence detecting onsets.

Spectrogram resolution can be increased in two ways. The first way is to sample the digital audio signal more often. For example, instead of sampling the digital audio 32 times a second with the hanning window, sampling could occur at a frequency of 64 or higher. Alternatively, the size of the hanning window can be decreased. As previously explained, due to Heisenberg uncertainty, there is a direct trade off between resolution in the frequency domain and resolution in the time domain. By making the hanning function smaller, temporal resolution is improved, which helps accuracy of note event detection since this detection depends significantly on temporal clues as discussed above.

A final element is how to bias the model in regard to precision versus recall. If the model makes predictions more aggressively, then it will be less likely to miss notes (high recall), but will over guess in some cases (lower precision). If the model makes predictions more tentatively, then it will miss more notes (low recall), but it will rarely guess incorrectly (high precision).

High precision models produce more accurate alignment results. While these high precision models have lower note recall, the missed notes are usually a part of a chord. As long as at least one note in each chord is correct, the alignment will remain accurate.

To increase the precision of the model, two techniques can be used. One is to use a focal loss function that allows the relative cost of precision versus recall errors during training to be modified. An additional technique is to modify precision versus recall by modifying the threshold function used when converting the probabilities output by the neural network into a definitive prediction.

### Running a Neural Network in Real-Time—Sliding Window Transcriber

In order to enable efficient transcription of streaming audio data, the artificial neural network can be adapted so that it can run efficiently and accurately in real time. To this purpose, an overlapping sliding window technique is utilized for feeding real-time data into the AI transcriber.

To run the real-time AI transcriber, 11 frames/batches of audio data are first collected. Given the above calculations, these 11 frames contain 5632 individual samples. This audio data will be used to ultimately produce a single 1/32 frame of the transcript.

From the audio data, a spectrogram is produced that is 229 frequency bins tall and 7 frames wide. The reason the frames shrink from 11 to 7 on creating the spectrogram is so that every hanning window used to create the spectrogram has access to 2048 samples of data. If the frames do not shrink, the Fourier algorithm would have to make predictions based on incomplete data. This in turn would impact the accuracy of the real-time technique.

Next, the spectrogram is fed into the first part of the onset and frames model (e.g. the 3-layer convolutional neural network). Convolution neural networks use convolutional filters which scan over the image fed into the network and produce filtered images from the original. With each layer of the convolutional neural network, it is normally expected that the horizontal and vertical dimensions of the output image to be 2 less than the input image. To prevent this, a technique called padding is typically used. With padding, an array of zeros is appended to each of the edges of the input image.

For this technique to be accurate, padding is avoided along the left and right edges of the input image. This padding of the time domain of the spectrogram will lead to artifacts if not eliminated. Due to this lack of left and right padding, the horizontal dimension of the output image (the frames) will shrink after each layer of the network from 7 to 5 to 3 to 1. At the end of this process, a single column of data remains representing the prediction for 1 frame of audio.

After the convolutional neural network, the data is next fed into a vanilla neural network. Subsequently, it is fed into a unidirectional LSTM. In processing data using the LSTM, the hidden state and cell state data is saved to memory between each pass of the real-time transcriber. This cell and hidden state data is then passed to the next pass of the network. This allows the LSTM to perform its function of integrating the predictions over time. The output of the LSTM is the final prediction for a single frame of audio data.

As the program runs, the sliding window will continually sample 7 frames from the spectrogram at a time. With each new pass of the game loop, the sliding window shifts 1 frame so that it is always sampling the newest data ready for processing.

In a further aspect, the first window of spectrogram data fed into the neural network transcriber includes padding along the left edge of the spectrogram. This padding accounts for the fact that the neural network may be originally trained on data samples that had this padding on the left edge. The neural network may use this padding to normalize itself. Without this padding the neural network may behave in an erratic fashion.

### Processing of the Music Transcript

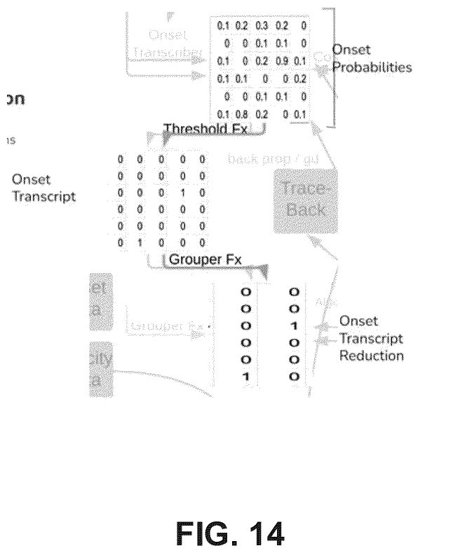

FIG. 14 depicts various transformations that occur during transcription. To briefly summarize, the input to the neural network transcriber is a matrix representing the spectrogram. The matrix has 229 rows to correspond with the 229 frequency bins used in calculating the spectrogram. The columns of the matrix correspond to time slices with a new time slice occurring every 1/32 second. For a ten second segment of audio, it is expected that the spectrogram has x, y dimension of 320 and 229.

The AI model utilizes a computer vision component and a recurrent neural network component. The desired output from this system is a matrix that is 88 notes tall corresponding to 88 notes on the piano and 315 columns wide. Some columns of data are loss due to the use of non-padding in the time domain when running our transcriber. In each cell of the matrix is the probability that a note occurred at a given moment of time. Probabilities range from 0 to a maximum of 1.

A threshold is chosen (such as 0.5) to determine which notes are active and which notes are inactive. If the prediction is above the threshold, the matrix location is set equal to “true” or 1. If the prediction is below the threshold, the prediction to “false” or 0. This results in a matrix containing binary information (0 or 1). This can be stored more efficiently. For example, rather than storing this data as a matrix of floating point numbers, it could be stored such that each cell is a bit. Thus, a bitarray data type can be employed. Instead of a matrix, an array of bitarrays is employed, where each bitarray represents the predictions at a given time stamp.

In an aspect, rather than use a bitarray that is 88 indices long, a 128 index bitarray may be used. Midi data classically contains 128 possible notes. Using a 128 index bitarray allows this structure to be directly compatible with midi processing algorithms. Secondly, using a 128 index bitarray means the scale does not need to change for each unique instrument. Third, the underlying architecture of conventional computers would result in a 128 bitarray internally.

Next, the consolidator or grouper function sequentially iterates through the columns of data in the onset transcript and throws away any columns that do not contain at least one active note. When it does identify a column with an active note, the consolidator checks to see if the column is within 50 ms of the last column to have been appended to the array. If the two columns are within 50 ms of each other, the columns are combined together using the OR bitwise operator to predict the combined output. The output of the OR operator then replaces the last appended column.

In an aspect, 50 ms is used as a threshold for chords as this is a common number discussed in the music information retrieval literature. 50 ms is sufficiently fast that it would not accidentally classify rapid notes played in succession as one large chord. Further, notes in a chord are typically played within 50 ms of each other.

Following the above operations, the live audio feedback system has converted the original audio into a transcript of the performance. As noted above, a bitarray can be used to represent all the active note onsets at a given position in the input sequence. Using an array of bitarrays, the sequential order of note and chords that have occurred during the user's performance can be represented. Next, this representation of the performance is compared to a similar array of bitarrays derived from parsing a digital representation of the score. A directed graph technique described below to accomplish this task.

To illustrate the directed graph approach, an example is described with a mono-harmonic sequence (one note at a time) of musical notes is matched to a mono-harmonic sequence derived from the score. Later, it will be described how to convert the mono-harmonic variation of directed graph alignment to real-time polyharmonic input.

### Directed Graph Technique for Sequence Alignment (Monoharmonic)

In considering how to most accurately annotate a score to show feedback errors, it can be observed that annotations provided to the users are a set of instructions on how they should edit their performance in order to match the score. Given a user's performance represented as input sequence X, the goal is to edit this sequence so that it matches a sequence Y representing the sequential order of musical events in the score. Deletion, addition, and/or substitution of notes can be used to mutate sequence X to create sequence Y.

For example, if sequence X is an array containing the following notes: [E,E,G,G,F,E,D] and Y is an array [E,E,F,G,G,F,E,D], then X can be converted to Y by inserting an F between E and G in the sequence. On the other hand, if X is [E,E,F, G,G,F,F,E,D], then Y can be produced by deleting the extra F between F and E in the sequence. If X is [E,E,F #,G,G,F,E,D], X can be converted to Y by changing the F # in sequence X to an F.

In each of the above examples, an optimal solution for editing a sequence X to produce a sequence Y is described. While these solutions are the optimal solution to the above problems, there are many other less efficient solutions for solving each of them. In order to prove a solution is optimal, all alternative solutions must be eliminated.

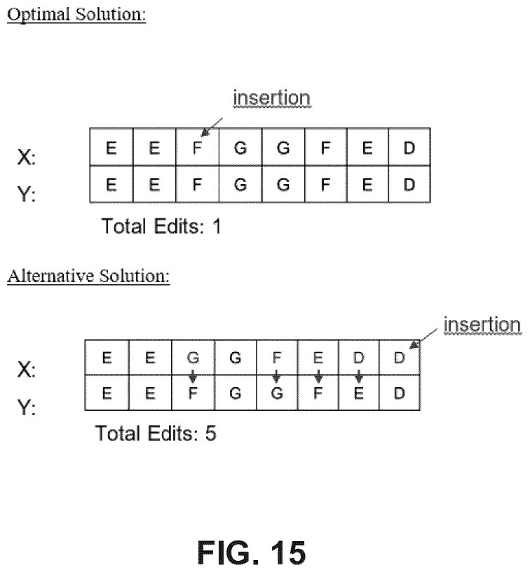

FIG. 15 illustrates the first example above and depicts an optimal solution with an alternative solution. In the solutions of FIG. 15, the optimal solution requires less edits because it edits X in such a way as to minimize mismatches between entries of X and Y. By inserting F at the appropriate place, the optimal solution avoids the chain reaction of mismatches and substitutions (illustrated by a down arrow) seen in the alternative solution.

It can be defined that the optimal solution is the solution that maximizes the number of correct matches between X and Y (i.e. when all types of edits (insertion, deletion, substitution) are scored equally when calculating the overall error.). Thus, the solution that produces the minimal number of edits is the solution that maximizes alignment between X and Y. Further, with the optimal alignment between the sequences, the edits necessary to produce that alignment are determined and can be translated into annotations on the score.

### Finding an Optimal Solution

In order to find the optimal alignment between sequence X and Y, three major tasks are accomplished. First, all possible alignments between sequences X and Y are identified. Second, a scoring system is developed in order to score the total number of edits required for each alignment. Third, a search strategy is developed to iterate through all possible alignments in order to produce the alignment with the lowest edit score.

A solution is to construct a directed grid graph so that every possible alignment can be modeled as a path traversing this graph. Similar to a travel map on which one can plot out every possible route between two points, this graph can be used to model all the alignments between two sequences of defined start point and end point. An optimization algorithm is used to efficiently search for the optimal path.

Given an input sequence (X=x₁x₂ . . . xₘ) and a sequence representing the order of musical events in a score (Y=y₁y₂ . . . yₙ), a graph is constructed with (m+1)*(n+1) nodes. Each node on the graph represents an alignment between a given index of X and Y. Since it is possible for the optimal solution to contain an alignment between any of indices of X with any of the indices of Y, m*n nodes are used to represent all these possible index alignments. Additional nodes in the graph account for the possibility that the solution may require entries to be appended to the beginning of either sequence. For example if X is EFGGFED and Y is EEFGGFED, the most efficient way to convert X to Y is to append an E to the beginning of X.

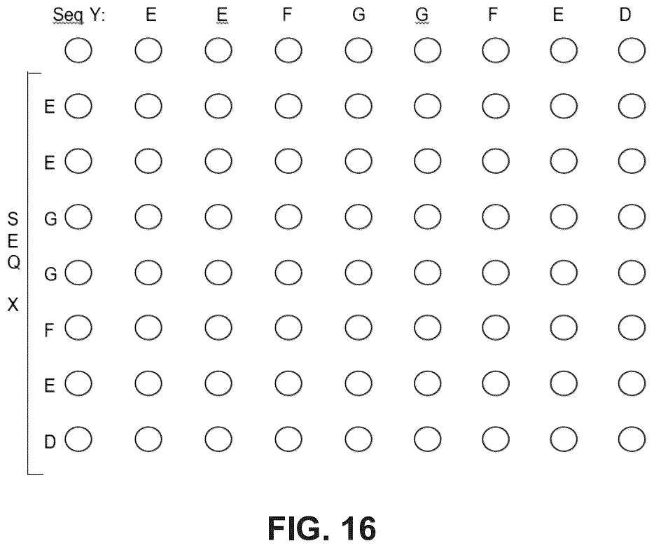

Using a grid graph, nodes can be plotted for a comparison between sequence X: [E,E,G,G,F,E,D] and Y: [E,E,F,G,G,F,E,D] as shown in FIG. 16. Given this representation, the columns in this grid graph represent indices of Y while the rows in the graph represent indices of X.

A set of rules can be defined for how paths are traversed on the graph. For instance, a node in the graph must exist so that there is one node to represent every pairing between an index of the input sequence and an index of the score sequence. The starting node is the node shown in the top left corner of the grid graph. The ending node is in the bottom right corner. The alignment path progresses from node to node so that the indices representing the nodes are monotonically increasing. (i.e. the path can transverse down, right, or diagonally down and right). The path cannot transverse up, left, or diagonally up and left.

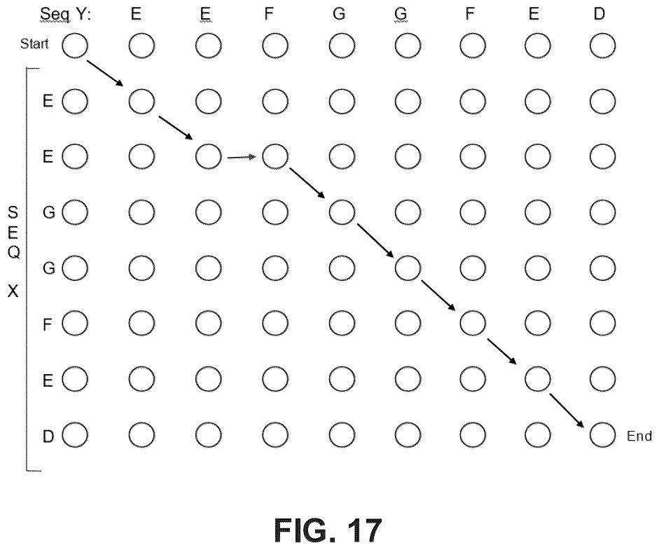

FIG. 17 illustrates the optimal alignment path plotted on the grid graph. In this example, the horizontal segment of the path represents the insertion of the letter F into Sequence X so that the remaining indices of X align with Y.

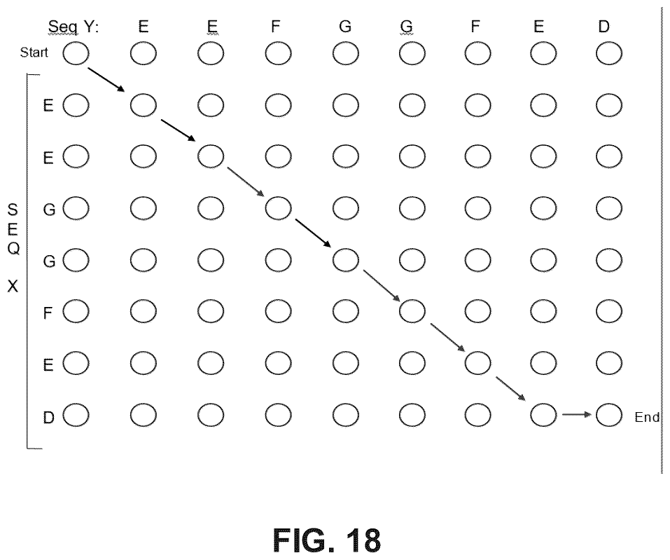

FIG. 18, in comparison, illustrates the alternative path described above.

Based on FIGS. 17 and 18, it becomes clear how to read the graph and to determine which edit events the graph is describing. For instance, insertion events are indicated in the graph by horizontal movement of the path. Deletion events are likewise indicated by vertical movement. Diagonal movement indicates an attempt to match the sequence entries represented by the target node.

To evaluate the two alignments graphed above, a scoring system is employed to track the overall edit cost related to each alignment. In an aspect, the scoring system can score both insertion and deletion +1. When a match check is performed (diagonal movement) and a mismatch is discovered, this is scored as +1. When the match check returns a match, this is scored as 0.

Using this scoring system, the optimal alignment (FIG. 17) is scored as 1 as it contains only one edit (an insertion). All other movements along this path are match checks resulting in a match (diagonal arrow). The alternative sequence (FIG. 18) scores 5 as it contains 4 mismatches (diagonal arrows) and an insertion (horizontal arrow).

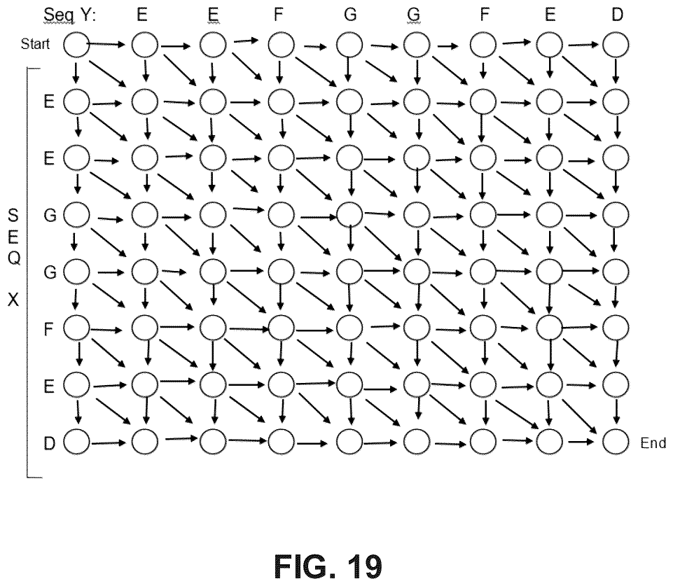

Above, a set of edits (insertion, deletion, and substitution (due to match check returning false)) is defined, which can be used to convert a sequence X into a sequence Y. Using a directed graph, every possible valid edit occurring at every match position between an index of X and Y can be modeled and visualized as shown in FIG. 19. Edits are considered valid if they comply with the rule set discussed above. For instance, edits are valid when they progress from node to node so that the indices representing the nodes are monotonically increasing. Additionally, edits are invalid if the alignment produced by the edit can only reach the end node by monotonically decreasing at some later point in the alignment.

Using the visualization of FIG. 19, searching through this graph to discover the global optimal alignment can be considered. For example, a brute force method could be used to iterate through every possible path that can transverse this graph, score all these possible paths, and identify the path that results in the lowest score.

Some observations illuminate a more efficient search strategy. If a given path P has been found to be the optimal path between the start node S and end node E, then every subpath of P must also be optimal. For example, there is a node M which exists along path P so that it divides path P into two smaller segments P₁ between point S and M and P₂ between points M and E. P₁ must be the optimal path between S and M and P₂ must be the optimal path between point M and E.

To prove this, consider there is an alternative path A₁ that lies between points S and M and is more optimal (has lower edit score) than path P₁. If this is the case, then there must also be some path A=A₁+P₂ that transverses the graph between point S and E. If the score of A₁<P₁, then the score of A₁+P₂<P₁+P₂. As A=A₁+P₂ and P=P₁+P₂, then the score of A<P. Therefore, P cannot be the optimal path between S and E if P₁ is not the optimal subpath between S and M. This logic generalizes to all subparts of the optimal path.

Using the above observation, an efficient search strategy can be devised. The directed graph allows points of intersection between competing alignment paths to be modeled. When alignment paths collide at a node, any suboptimal alignment paths arriving at that node can be ruled out. It is not possible for these alignment paths to be a subpart of the optimal solution. Thus, it is not necessary to track every alignment path until it terminates at the end point. Rather, paths can be simply tracked until they collide with a more optimal path.

The search strategy first calculates the optimal path to the nodes closest to the start position. Given the optimal score of each of these most proximal nodes, there is sufficient information to calculate the optimal score and path to the next “layer” of nodes slightly farther away from the start position. In this fashion, the search can systematically progress through the graph calculating the optimal score and path to every node in the graph. At the end node, the path and score of this end node represents the optimal alignment and optimal edit distance.

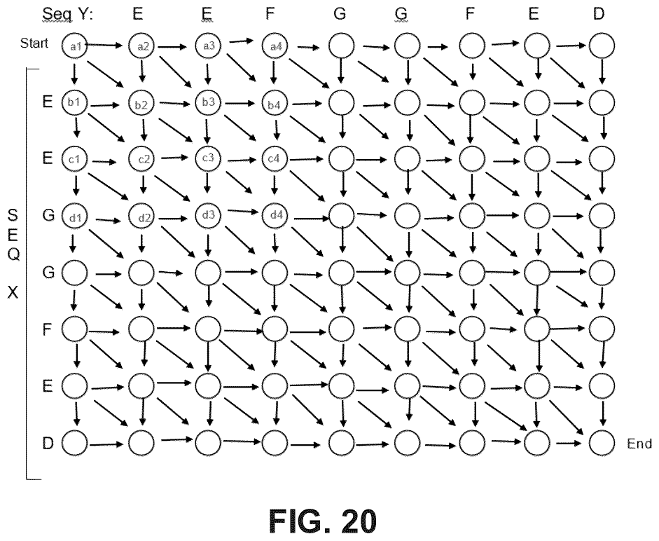

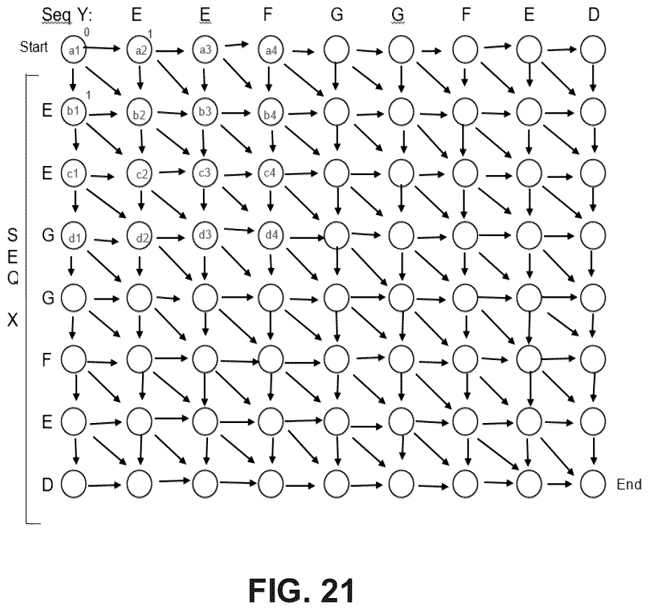

FIGS. 20-22 illustrate this strategy. In FIG. 20, the nodes in the first four rows and first four columns of the graph are labeled. An optimal edit distance to the nodes in this 16 node section of the graph is calculated. The start node a1 receives a score of 0 as no edits have been made at this point in the graph. Some of the nodes adjacent to a1 (a2 and b1) only have one path leading into them. The optimal cost to arrive at these nodes is calculated simply by knowing the cost of horizontal (insertion) and vertical (deletion) movement in the graph. Accordingly, the optimal path to a2 has a cost of 1 and the optimal path to b1 has a cost of 1 as shown in FIG. 21.

In FIG. 21, the numbers record the edit cost of the optimal path to each of the nodes solved so far. With the nodes a1, a2, and b1 solved, there is sufficient information to determine the optimal edit path to c1, b2, and a3. The optimal path to c1=(optimal path between a1 and b1)+(optimal path between b1 and c1)=1+1=2. a3 similarly has a cost of 2.

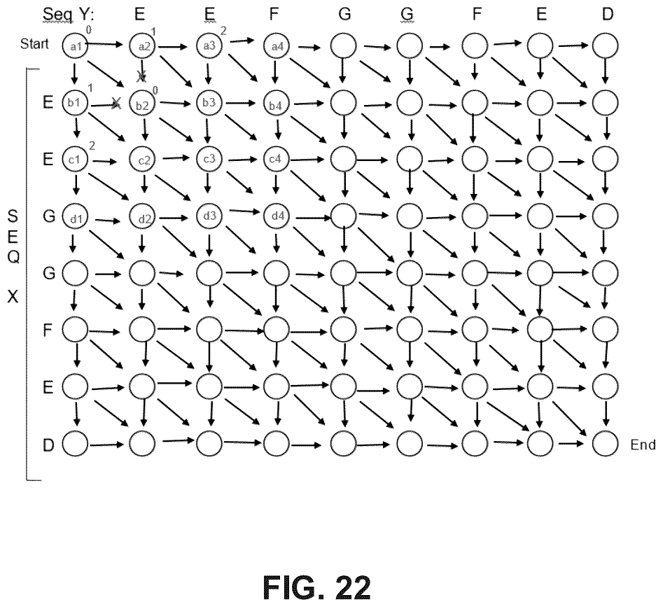

To calculate the cost to arrive at b2, the minimum of the three paths arriving at this node is determined. For example, the first path has a cost of 2 (e.g. (cost a1 to a2)+(cost a2 to b2)=2), the second path has a cost of 0 (e.g., (cost a1 to b2)=0), and the third path has a cost of 2 (e.g., (cost a1 to b1)+(cost b1 to b2)=2). Thus, the optimal path arriving at b2 is the diagonal movement from a1 given the fact this movement is scored as 0 due to Sequence X and Y matching at this node. FIG. 22 illustrates the result of this calculation.

At this point, there is sufficient information to solve for nodes d1, c2, b3, and a4. From there, the process can continue by solving for every node left in the graph until reaching the end node.

In FIG. 22, there are two X's added to two of the arrows. This indicates that these subpaths have been eliminated from consideration of the optimal path. These subpaths cannot be part of the optimal solution as the paths themselves are suboptimal. Many possible paths will be eliminated as the method progresses through the graph calculating the best possible edit score for each of the nodes. In this example, by the time the end node is reached, only one continuous path between the start node and end node remains. This path is the optimal alignment path.

To implement the directed graph method, a matrix (e.g. my_interactive_score.directed_graph_matrix) is used to store the value of the optimal edit cost for each node in the graph. The matrix is iterated through row by row, calculating the optimal edit cost of each node in a fashion similar to above. Given calculations for all entries in our matrix, the optimal path for this matrix can be determined.

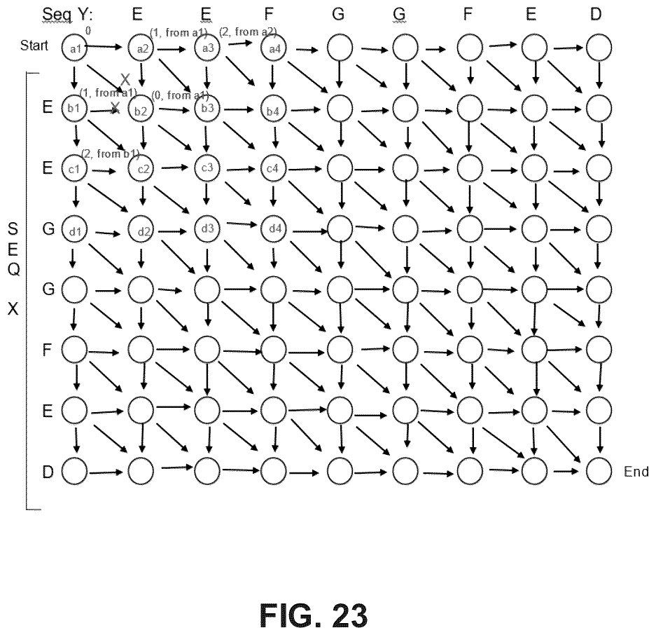

The optimal path is determined by performing a traceback from the end node to the start node. For each node in the directed graph, the edit cost for each of these nodes is calculated and stored in a cell of the matrix. A pointer describing the direction the optimal path entering that node came from can also be stored. FIG. 23 illustrates this aspect.

As shown in FIG. 23, these pointers are analogous to bread crumbs placed to allow for traceback to the start node. If this process begins at the end node, the optimal alignment can be systematically discovered by following these pointers backwards. The edits required to produce the alignment can be recorded. These edits directly indicate which edits or annotations to add to the score.

### Directed Graph Technique for Sequence Alignment (Polyharmonic)

The above example applied to monoharmonic situations. In considering real-time polyharmonic situation, there are two major considerations with the directed graph method above. The first consideration is that the directed graph checks for equality between a given index of X and a given index of Y in a binary fashion. While this formulation works well for mono-harmonic music sequences, polyharmony is different. With polyharmonic sequences, if any note in the input chord does not match the chord in the score, then the entire chord in the score will be marked as incorrect. This subsequently leads to multiple downstream consequences. The first consequence is that many notes that the user played correctly are marked incorrect due to this chord issue. That leads to a further consequence in which the inability to give appropriate credit affects the accuracy of the alignment path and can cause that path to be shifted. Therefore, the software may not only annotate mistakes where there are none it may also annotate these mistakes in the wrong place.

A second consideration is that the feedback can change suddenly as the user plays through the piece. To address this, the system accounts for the fact that the alignment method is used for real-time performance. This results because the direct graph scoring system continues to score the transcript until the end node is reached. In other words, it attempts to account for every index in the input sequence as well as every index in the score. By attempting to account for every index in the score, the program is essentially penalizing the user for notes they have not yet played.

For example, if a user is playing a piece with 60 notes and they play the first note correctly, then the algorithm will give the user credit for the first correct note but then score them as having missed the other 59 notes in the piece. An immediate first problem is that the system may attempt to show missed note annotations for these 59 missing notes. Even if this is solved by hiding those annotations, additional problems remain. One problem is that the note just played may match with multiple score positions. While it may be correct to align the note played to the first note in the score, per the scoring system, it may be equally correct to align it to another position such as the 43rd position in the score. This could be solved by defining hand-written rules that allow the most intuitive alignment to be selected in most cases. However, this still does not solve all problems. For instance, when the most recent note played by the user is incorrect, the alignment system may jump far ahead in the sheet music to find a match for this note. This will lead to erratic score following with the software jumping back and forth in the score during the performance.

As previously discussed, the input sequence is represented as an array of bitarrays. For example, consider a situation where a first bitarray represents a chord the user has played and a second bitarray is a chord written in the score. To determine the total number of errors which have occurred, any notes in the input sequence that are not present in the score sequence are identified and any notes in the score sequence that are not present in the input sequence are also identified. An XOR function accomplishes this goal by preserving information regarding both types of errors. To determine the total number of the errors that have occurred, the number of positive indices in the output of the XOR function are counted. Using this technique, the edits needed to match polyharmonic data can be calculated. Using this tool, a new scoring system is created for the polyharmonic directed graph method.

As described above, the scoring system utilized an equality function to check for matches between indices of X and indices of Y. Now, with polyharmonic data, matches are checked by comparing the bitarrays of X and Y using the XOR function and counting the number of errors. Further, insertion or deletion in the computational graph were previously scored as each costing 1 edit. With polyharmonic data, an edit may be to insert or delete a chord with multiple notes. For example, an edit may delete a chord with three notes. Instead of scoring this deletion event as 1, it would be correctly scored as 3 edits. The polyharmonic version of our algorithm scores these deletion and insertion events by counting the number of positive indices in the deleted or inserted chord. With this simple rule set, polyharmonic sequence matching is possible.

When playing through sheet music in real-time, inconsistent alignment may be possible. This results from attempting to score the alignment until the end goal node (e.g. end of piece) is reached. This penalizes the user for notes they have not yet played. The solution is to redefine the goal of the alignment. While the previous goal was to account for all indices of both the input sequence X and score Y, it would be reasonable to only account for the indices of X. Thus, the goal is to find the alignment pathway that accounts for all the indices of X at lowest overall edit cost. This can be accomplished by slightly redefining the scoring system. In order to account for all the positions in the input, the alignment needs to reach the bottom row of the directed graph. Once the alignment reaches the bottom row, it must transverse horizontally to reach the end node. This horizontal movement (deletion) along the bottom row should be scored as zero.

### Displaying Feedback

To determine and display feedback, some calculations are made. These calculations include calculating the correct notes of a partial match using the bitwise AND function to compare the bitarray of the input sequence with the bitarray from the score. The AND function returns the notes in common, i.e. the correct notes. To calculate the missing notes of a partial match (notes in the score but not in the input), the following bitwise equation is used: score bitarray AND (score bitarray XOR input bitarray). To calculate substituted notes of a partial match (notes in the input but not in the score), the following bitwise equation is used: input bitarray AND (score bitarray XOR input bitarray). To calculate added notes after a score position, the deletions shown in the directed graph at a given score position are recorded. These deletion events are recorded in an array so they are kept in sequential order. To calculate volume feedback, the time stamp of each bitarray in our input sequence is first recorded. Then, these time stamps are used to look up onset and frames volume prediction for relevant notes at that time stamp. To calculate rhythm feedback, the time difference between input bitarrays aligned to adjacent score positions are determined. The interval tempo given the time difference and the number of musical beats between the score positions is determined.

Note, volume, and rhythm feedback is annotated by using positional data stored in my_interactive_score.local_score_data. For each musical line, the positional data contains information on the location of that line, musical ledger lines belonging to that line, and score positions (horizontal position) along that line. This information is used to find the correct score and ledger line position to annotate our correct note, missed note, and substituted note annotations. For added notes, this information is annotated on the correct ledger line and between the current score position and the next. Added notes are spaced such that the deletion events in the array are equally spaced.

Volume feedback is annotated by changing the color of each note feedback annotation to indicate the intensity of the sound. Rhythm feedback is shown by drawing a semi-transparent rectangle to the screen. The horizontal span of the rectangle is the distance between a given score position and the next score position. The vertical span of the rectangle is the span between the staves. The color of the rectangle is used to indicate the tempo of the performance over the interval between a given score position and the next score position. The rectangles stack horizontally to show the variation in the user's tempo and rhythm.

### Exemplary Implementation of a Live Midi Feedback System

A possible implementation of the performance feedback system and method described above is now described. This implementation merely exemplifies one possible manner in which to carry off the aspects and functionality described above. One of ordinary skill in the art would appreciate alternative implementations based on the description herein. This implementation is not intended to limit the claimed subject matter, but simply provides a detailed example of the general system and method above.

In this embodiment, live streaming midi data is substituted as an input source to our feedback system. This is as opposed to live streaming audio. By sampling this midi data, an array of bitarrays is produced which is compared to an array of bitarrays from the sheet music. An alignment is produced from the comparison in a similar fashion as previously discussed. From this alignment, feedback can be generated and provided to the user.

To sample streaming midi data, a midi processing library such as mido is used to establish a connection to the user's midi device. Subsequently, each time our game loops, the process_input( ) function is called. Process input will then iterate through all midi messages saved to a buffer. If the midi messages are of the ‘note_on’ type, the algorithm will form a bitarray to represent the ‘note_on’ event and append the bitarray to an array representing the performance. As it does this, it will timestamp each bitarray. If two adjacent bitarrays are within 50 ms of each other, they are combined together to form a chord. For each bitarray, timestamp and velocity information is preserved so that the feedback system can utilize this information to provide feedback on rhythm and volume.

While midi is used above as an example of a communication protocol for transporting electronic music information, we contend that any number of communication protocols could be used to transport similar information.

### Exemplary Implementation of a Live Page Turning System

A possible implementation of the performance feedback system and method described above is now described. This implementation merely exemplifies one possible manner in which to carry off the aspects and functionality described above. One of ordinary skill in the art would appreciate alternative implementations based on the description herein. This implementation is not intended to limit the claimed subject matter, but simply provides a detailed example of the general system and method above.

In this embodiment, an alignment is produced by one of the live feedback systems discussed above. This alignment is used to provide the program with the location of the current score position. The program has access to data regarding the score positions which are located on the current page of the sheet music. It uses this data to determine the proximity of the user to the last score position on the page. When the user exceed some predetermined threshold of proximity to the last score position, a page turn event is initiated.

The page turn is implemented by changing the background image of the program to the new page of sheet music, erasing annotations from the score, and resetting data structures necessary for live feedback. For example, my_interactive_score.local_sheet_music_data might be reset to reflect the data located on the current page. Other feedback data structures suce as input sequence, directed_graph_matrix, feedback_data, and feedback_sprites might be reset if necessary. With these update, the user can now practice the musical material written on the new page.

### Exemplary Implementation of a Pre-Recorded Audio Feedback System

A possible implementation of the performance feedback system and method described above is now described. This implementation merely exemplifies one possible manner in which to carry off the aspects and functionality described above. One of ordinary skill in the art would appreciate alternative implementations based on the description herein. This implementation is not intended to limit the claimed subject matter, but simply provides a detailed example of the general system and method above.

In this embodiment pre-recorded audio is substituted for a live audio stream. Fourier transformation is performed on the audio file and the result is fed into the AI transcriber. This produces an input sequence which can be aligned with the score.

In addition to feeding audio into the AI transcriber at once, alternatively this data could be fed into the transcriber in a piecemeal fashion so that the feedback updates over time and live performance is therefore imitated.

### Exemplary Implementation of a Pre-Recorded Midi Feedback System

A possible implementation of the performance feedback system and method described above is now described. This implementation merely exemplifies one possible manner in which to carry off the aspects and functionality described above. One of ordinary skill in the art would appreciate alternative implementations based on the description herein. This implementation is not intended to limit the claimed subject matter, but simply provides a detailed example of the general system and method above.

In this embodiment pre-recorded midi is substituted for a live midi stream. Midi can be converted into an array of bitarrays. By comparing this to an array of bitarrays from the score, feedback can be provided.

Alternatively, the midi data could be parsed in a piecemeal fashion so as to update the feedback iteratively and imitate live performance.

### Additional Graph Techniques for Sequence Alignment

In addition to this sequence alignment strategies previously discussed, it is noted that there are numerous ways in which the directed graph method previously described could be modified and still produce useful results. For example, instead of using a set of nodes that represent every possible alignment from indices on an input array X and an array representing the score Y, one could instead utilize only a subset of these nodes. It is observed that some nodes are less likely to be a part of the optimal solution than other nodes. As a result, one might consider removing nodes that are unlikely to impact the optimal alignment. Other nodes, such as the start node, may not be critical to an effective alignment strategy.

Myriad search strategies can be devised for searching a directed graph in an efficient manner.

As a substitute for the polyharmonic alignment method previously discussed, it is appreciated that polyharmonic data can be unfurled into a mono-harmonic sequence. For example, after the consolidator function groups input notes into chords, one might unfurl the chord into a mono-harmonic sequence with the lowest note in the chord being the first note in the sequence and the highest note coming last in the sequence. One could unfurl chords in the score in a similar manner. Subsequently mono-harmonic alignment can be performed on the resulting sequences.

Computational efficiency of the directed graph method can also be improved. For example, when the input sequence updates, the update should only affect the calculations in the bottom 1-2 rows of the directed graph method. The number of rows affected depends on the specific variant of the directed graph method. As such calculations above these rows do not need to be repeated. An additional possibility for improving computational efficiency is utilizing look up tables.

### Additional Input Representations for Sequence Alignment

In addition to the input representations previously described, it is noted that numerous other representations can be utilized to compare information in the musical performance to information in the sheet music. For example, chroma features or fundamental harmonics could be used as a substitute for notes. These representation are more robust and reliable than note transcription but are less descriptive.

It is also noted that the feature vector of a neural network transcriber could also be utilized to construct a unique language of music for use in alignment. Using the neural network we can map note combination examples from a training dataset into multidimensional feature vector space. In this multidimensional space, similar note combinations can be seen to cluster together. An unsupervised learning technique (for example k-means clustering) can then be used to draw boundaries between clusters so that clusters are maximally contained by the groups demarcated by these boundaries. The number of boundaries is a hyperparameter that can be tuned to increase the descriptiveness of our musical language at the cost of transcription robustness. Next, the groups are named and all the note combinations which exist primarily within the bounds of each group are identified. Using this information, audio data can be transcribed into this musical language by assigning each event in the audio to a group. Score information can be translated into the music language by looking up which group is associated with each note combination occurring in the score. Subsequently, alignment can occur between the performance and the score.

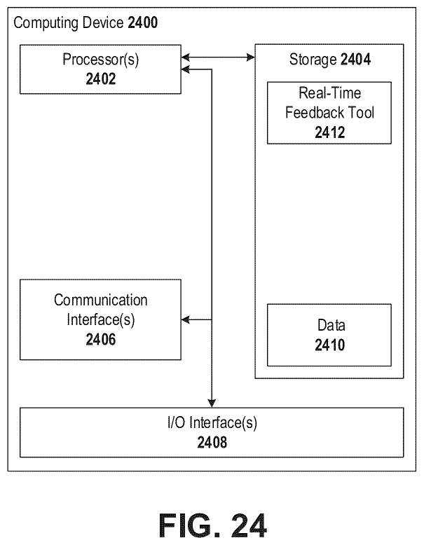

FIG. 24 illustrates a schematic block diagram of an exemplary, non-limiting embodiment for a computing device 2400. The systems and methods described above may be performed by computing device 2400. As shown in FIG. 24, computing device 24000 includes one or more processor(s) 2402 configured to execute computer-executable instructions such as instructions composing real-time feedback tool 2412 (similar to the systems and methods described above, e.g. performance evaluation engine 100, etc.). Such computer-executable instructions can be stored on one or more computer-readable media including non-transitory, computer-readable storage media such as storage 2404. For instance, storage 2404 can include non-volatile storage to persistently store real-time feedback tool 2412, and/or data 2410. Storage 2404 can also include volatile storage that stores real-time feedback tool 2412 and other data 2410 (or portions thereof) during execution by processor 2402.

Computing device 2400 includes a communication interface 2406 to couple computing device 2400 to various remote systems or devices. Communication interface 2406 can be a wired or wireless interface including, but not limited to, a WiFi interface, an Ethernet interface, a fiber optic interface, a cellular radio interface, a satellite interface, etc. An I/O interface 2408 is also provided to couple computing device 2400 to various input and output devices such as displays, touch screens, keyboards, mice, touchpads, microphones, instruments, etc. By way of example, I/O interface 2408 can include wired or wireless interfaces such as, but not limited to, a USB interface, a serial interface, a WiFi interface, a short-range RF interface (Bluetooth), an infrared interface, a near-field communication (NFC) interface, etc.

The word “exemplary” is used herein to mean serving as an example, instance or illustration. Any aspect or design described herein as “exemplary” is not necessarily to be construed as advantageous over other aspects or designs. Rather, use of the word exemplary is intended to present concepts in a concrete fashion. As used in this application, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. Further, at least one of A and B and/or the like generally means A or B or both A and B. In addition, the articles “a” and “an” as used in this application and the appended claims may generally be construed to mean “one or more” unless specified otherwise or clear from context to be directed to a singular form.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims. Of course, those skilled in the art will recognize many modifications may be made to this configuration without departing from the scope or spirit of the claimed subject matter.

Also, although the disclosure has been shown and described with respect to one or more implementations, equivalent alterations and modifications will occur to others skilled in the art based upon a reading and understanding of this specification and the annexed drawings. The disclosure includes all such modifications and alterations and is limited only by the scope of the following claims. In particular regard to the various functions performed by the above described components (e.g., elements, resources, etc.), the terms used to describe such components are intended to correspond, unless otherwise indicated, to any component which performs the specified function of the described component (e.g., that is functionally equivalent), even though not structurally equivalent to the disclosed structure which performs the function in the herein illustrated exemplary implementations of the disclosure.

In addition, while a particular feature of the disclosure may have been disclosed with respect to only one of several implementations, such features may be combined with one or more other features of the other implementations as may be desired and advantageous for any given or particular application. Furthermore, to the extent that the terms “includes,” “having,” “has,” “with,” or variants thereof are used in either the detailed description or the claims, such terms are intended to be inclusive in a manner similar to the term “comprising.”

The implementations have been described, hereinabove. It will be apparent to those skilled in the art that the above methods and apparatuses may incorporate changes and modifications without departing from the general scope of this invention. It is intended to include all such modifications and alterations in so far as they come within the scope of the appended claims or the equivalents thereof.

1. A system, comprising:
a processor coupled to a memory having computer-executable instructions that, when executed by the processor, configure the processor to:
generate an input transcript from input of a musical performance;
generate a reference transcript from a musical score associated with the input;
determine an alignment between the input transcript and the reference transcript using a directed graph technique; and
output feedback on the musical performance based on the alignment determined.

2. The system of claim 1, wherein generation of the input transcript and determination of the alignment occurs in real time.

3. The system of claim 1, wherein, to determine the alignment, the processor is further configured to:
generate a grid graph based on the input transcript and the reference transcript;
traverse the grid graph to identify one or more paths of alignment;
evaluate the one or more paths of alignment based on one or more criteria; and
select the alignment from the one or more paths of alignment as a solution.

4. The system of claim 1, wherein the processor is further configured to identify a series of edits, based on the alignment, to transform the input transcript into the reference transcript.

5. The system of claim 4, wherein the processor is further configured to:
generate annotations based on the series of edits; and
output display data based on the annotations to display the feedback on the musical performance,
wherein the annotations are displayed in connection with a visual representation of the musical score.

6. The system of claim 4, wherein an edit of the series of edits is one of a note insertion, a note deletion, or a note substitution.

7. The system of claim 1, wherein the processor is further configured to:
generate a volume prediction based on the input of the musical performance; and
output volume feedback on the musical performance based on the volume prediction.

8. The system of claim 1, wherein the processor is further configured to:
acquire timing information associated with the input of the musical performance;
identify reference timing based on the musical score;
determine a tempo of the musical performance based on the alignment, the timing information, and the reference timing; and
output tempo feedback on the musical performance based on the tempo determined,
wherein the tempo feedback is visually displayed on a visual representation of the musical score.

9. The system of claim 1, wherein, to generate the input transcript, the processor is further configured to:
process digital input of the musical performance captured by an input device;
input processed digital input to a neural network to generate note onset probabilities;
apply a threshold to the note onset probabilities to determine actual note onset;
consolidate notes having onsets within a predetermined amount of time; and
output a representation of active notes, after consolidation, as the input transcript.

10. The system of claim 9, wherein the digital input is a digital audio input captured by an audio input device.

11. The system of claim 9, wherein the digital input is digital musical information communicated by the input device using a communications protocol.

12. The system of claim 9, wherein the processor is further configured to train the neural network using pre-recorded performances.

13. A method for providing real time feedback on a musical performance, comprising:
acquiring input of the musical performance;
generating an input transcript of the musical performance based on the input;
comparing the input transcript to a reference transcript of a musical score associated with the musical performance to determine an alignment;
generating annotations based on the alignment, wherein the annotations include corrective transformations to the musical performance; and
displaying, in real time, the annotations on a rendered representations of the musical score as feedback to a performer.

14. The method of claim 13, wherein the input transcript includes polyharmonic information and is represented as an array of bitarrays.

15. The method of claim 13, wherein comparing the input transcript to the reference transcript further comprises applying a directed graph technique to determine the alignment.

16. The method of claim 13, further comprising determining the alignment by:
generating a grid graph based on the input transcript and the reference transcript;
traversing the grid graph to identify one or more paths of alignment;
evaluating the one or more paths of alignment based on one or more criteria; and
selecting the alignment from the one or more paths of alignment as a solution.

17. The method of claim 13, further comprising identifying a series of edits, based on the alignment, that transform the input transcript into the reference transcript,
wherein generating the annotations includes generating the annotations based on the series of edits, and
wherein an edit of the series of edits is one of an insertion, a deletion, or a substitution.

18. The method of claim 13, further comprising:
generating a volume prediction based on the input of the musical performance; and
displaying volume feedback on the musical performance based on the volume prediction.

19. The method of claim 13, further comprising:
acquiring timing information associated with the input of the musical performance;
identifying reference timing based on the musical score;
determining a tempo of the musical performance based on the alignment, the timing information, and the reference timing; and
displaying tempo feedback on the musical performance based on the tempo determined.

20. A non-transitory, computer-readable storage medium having stored thereon computer-executable instructions that, when executed by a processor, configure the processor to:
acquire digital input of the musical performance captured by an input device;
process a sample of the digital input and provide processed digital input to neural network to generate active note probabilities;
apply a threshold to the active note probabilities to determine actual active notes;
group active notes occurring within a predetermined amount of time;
append grouped active notes associated with the sample to a data structure representing an input transcript of the musical performance;
generate a grid graph based on the input transcript and a reference transcript corresponding to a musical score associated with the musical performance;
traverse the grid graph to identify one or more paths of alignment;
evaluate the one or more paths of alignment based on one or more criteria;
select an alignment from the one or more paths of alignment as a solution alignment;
identify a series of edits, based on the solution alignment, to transform the input transcript into the reference transcript;
generate annotations based on the series of edits; and
output display data for displaying the annotations in connection with a visual representation of the musical score in real-time as feedback on the musical performance,
wherein the display data is automatically updated to change the visual representation of the musical score during the performance to simulate a page turn event.
